(19) United States
(12) Patent Application Publication
(10) Pub. No.: US 2017/0185596 A1
(43) Pub. Date: Jun. 29, 2017

(54) TRIGGER-BASED CONTENT PRESENTATION

(71) Applicant: Gary Spirer, Austin, TX (US)

(72) Inventor: Gary Spirer, Austin, TX (US)

(21) Appl. No.: 15/397,647

(22) Filed: Jan. 3, 2017

Related U.S. Application Data
(63) Continuation-in-part of application No. 13/943,708, filed on Jul. 16, 2013, now Pat. No. 9,535,577.
(60) Provisional application No. 61/672,110, filed on Jul. 16, 2012.
(60) Provisional application No. 61/791,191, filed on Mar. 15, 2013.

(51) Int. Cl. G06F 17/30; G06F 17/22; G06Q 30/02

(52) U.S. Cl. CPC G06F 17/30029; G06Q 30/0201; G06F 17/2247; G06F 17/2235

(57) ABSTRACT

An apparatus, method, and computer program product are disclosed for trigger-based content presentation. A trigger module detects a triggering event. A response module determines a content element to present to a user in response to the triggering event. The content element may include a multimedia element and one or more interactive content elements that are synchronized with the multimedia element such that the one or more interactive content elements are presented at predetermined points during presentation of the multimedia element. A presentation module presents the determined content element on a device of the user.

### CROSS-REFERENCES TO RELATED APPLICATIONS

This application claims the benefit of U.S. Provisional Patent Application No. 61/672,110 entitled “APPARATUS, METHOD, AND COMPUTER PROGRAM PRODUCT FOR SYNCHRONIZING INTERACTIVE CONTENT WITH MULTIMEDIA” and filed on Jul. 16, 2012, for Gary Spirer, which is incorporated herein by reference. This application also claims the benefit of U.S. Provisional Patent Application No. 61/791,191 entitled “APPARATUS, METHOD, AND COMPUTER PROGRAM PRODUCT FOR SYNCHRONIZING INTERACTIVE CONTENT WITH MULTIMEDIA” and filed on Mar. 15, 2013, for Gary Spirer, which is also incorporated herein by reference. This application also claims the benefit of U.S. patent application Ser. No. 13/943,708 entitled “APPARATUS, METHOD, AND COMPUTER PROGRAM PRODUCT FOR SYNCHRONIZING INTERACTIVE CONTENT WITH MULTIMEDIA” and filed on Jul. 16, 2013, for Gary Spirer, which is also incorporated herein by reference.

### FIELD

This invention relates to displaying multimedia content and more particularly relates to presentation of multimedia content in response to triggering events.

### BACKGROUND

In general, multimedia may include static images, motion pictures, sound recordings, etc., which may be consumed on an electronic device, such as a computer, smart phone, etc. Businesses and organizations may take advantage of different multimedia content to advertise their products, market to target groups, etc. In particular, businesses may share present multimedia using a variety of online distribution methods, such as social networks, email, text messages, etc. Traditional multimedia content, however, usually does not allow the user to interact with the content.

It may be desirable to allow multimedia consumers to interact with the multimedia content, which may have advantages for both the consumer and the content creator. A content creator may want to gain feedback about products, gain statistical data about a marketing campaign, etc. from their consumers. Consumers may want a more immersive multimedia experience and may also want to provide feedback on products, advertising, etc., that they consume.

### BRIEF SUMMARY

From the foregoing discussion, it should be apparent that a need exists for an apparatus, method, and computer program product for trigger-based content presentation. The present disclosure has been developed in response to the present state of the art, and in particular, in response to the problems and needs in the art that have not yet been fully solved by currently available multimedia presentation methods. Accordingly, the present disclosure has been developed to provide an apparatus, method, and computer program product for trigger-based content presentation that overcome many or all of the above-discussed shortcomings in the art.

In one embodiment, an apparatus is disclosed that includes a trigger module that detects a triggering event. The apparatus, in a further embodiment, includes a response module that determines a content element to present to a user in response to the triggering event. The content element may include a multimedia element and one or more interactive content elements that are synchronized with the multimedia element such that the one or more interactive content elements are presented at predetermined points during presentation of the multimedia element. In certain embodiments, the apparatus includes a presentation module that presents the determined content element on a device of the user.

The apparatus, in a further embodiment, includes an intelligence module that further determines the content element presented to the user based on descriptive data associated with the user. The descriptive data may be selected from one or more of a user profile and an affinity database. In one embodiment, the intelligence module determines one or more additional content elements to present to the user based on the triggering event, input received from the user, and the descriptive data associated with the user. The user input may be received in response to the user providing a response to the one or more of the interactive content elements.

In some embodiments, the intelligence module queries one or more external data sources using the user input to determine the one or more additional content elements to be presented to the user. In various embodiments, the intelligence module dynamically determines the one or more additional content elements presented to the user in real time in response to the user interacting with the one or more interactive content elements. In another embodiment, the affinity database stores descriptive data comprising one or more of preferences, demographics, interests, and shopping trends of the user.

In certain embodiments, the apparatus includes a profile module that generates a profile for the user based on the user's responses to the one or more interactive content elements. The profile may include descriptive data for the user. In a further embodiment, the response module determines the content element presented to the user based on the descriptive data in the user's profile. One or more of the multimedia element and the one or more interactive content elements may be selected based on the descriptive data in the user's profile.

In one embodiment, the response module determines the content element presented to the user from one or more preselected content elements for the user where each preselected content element includes a multimedia element and one or more interactive content elements. In a further embodiment, a content element of the one or more preselected content elements is selected for presentation to the user based on the user's response to one or more interactive content elements associated with a currently presented multimedia element.

In one embodiment, the triggering event includes receiving a signal from one or more external devices. The content element that is presented to the user may be determined based on the received signal. In another embodiment, the triggering event includes receiving input from one or more sensors. The content element that is presented to the user may be determined based on the sensor input.

In one embodiment, the triggering event includes determining a location of the user. The content element that is presented to the user may be determined based on the determined location. In some embodiments, the determined location includes a location within a store. The content element that is presented to the user may be associated with one or more products related to the user's location. In a further embodiment, the trigger module sends a signal to one or more external devices in response to user input. The signal may trigger one or more actions on the one or more external devices.

A method is disclosed that, in one embodiment, includes detecting a triggering event. The method, in a further embodiment, includes determining a content element to present to a user in response to the triggering event. The content element may include a multimedia element and one or more interactive content elements that are synchronized with the multimedia element such that the one or more interactive content elements are presented at predetermined points during presentation of the multimedia element. In some embodiments, the method includes presenting the determined content element on a device of the user.

In one embodiment, the method includes determining the content element that is presented to the user based on descriptive data associated with the user. The descriptive data may be selected from one or more of a user profile and an affinity database. One or more additional content elements that are presented to the user may be determined based on the triggering event, input received from the user, and the descriptive data associated with the user. The user input may be received in response to the user providing a response to the one or more of the interactive content elements.

In a further embodiment, the method includes dynamically determining, in real time, the one or more additional content elements presented to the user. In some embodiments, the method includes determining the content element presented to the user from one or more preselected content elements for the user. Each preselected content element may include a multimedia element and one or more interactive content elements. A content element of the one or more preselected content elements may be selected for presentation to the user based on the user's response to one or more interactive content elements associated with a currently presented multimedia element.

A computer program product is disclosed that includes a computer readable storage medium having computer readable program code embodied therewith. In one embodiment, the computer readable program code is configured to detect a triggering event. In another embodiment, the computer readable program code is configured to determine a content element to present to a user in response to the triggering event. The content element may include a multimedia element and one or more interactive content elements that are synchronized with the multimedia element such that the one or more interactive content elements are presented at predetermined points during presentation of the multimedia element. The computer readable program code, in another embodiment, is configured to present the determined content element on a device of the user.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of system for trigger-based content presentation in accordance with the subject matter disclosed herein;

FIG. 2 is a schematic block diagram illustrating one embodiment of an apparatus for trigger-based content presentation in accordance with the subject matter disclosed herein;

FIG. 3 is a schematic block diagram illustrating another embodiment of an apparatus for trigger-based content presentation in accordance with the subject matter disclosed herein;

FIG. 4 is an illustration of an embodiment of an interface for synchronizing interactive content with multimedia in accordance with the subject matter disclosed herein;

FIG. 5 is a schematic flow chart diagram illustrating one embodiment of a method for synchronizing interactive content with multimedia in accordance with the subject matter disclosed herein;

FIG. 6 is a schematic flow chart diagram illustrating another embodiment of a method for synchronizing interactive content with multimedia in accordance with the subject matter disclosed herein;

FIG. 7 is a schematic flow chart diagram illustrating an embodiment of a method for creating synchronized interactive content with multimedia in accordance with the subject matter disclosed herein;

FIG. 8 is a schematic flow chart diagram illustrating another embodiment of a method for creating synchronized interactive content with multimedia in accordance with the subject matter disclosed herein;

FIG. 9 is an illustration of an embodiment of an interface for creating synchronized interactive content with multimedia in accordance with the subject matter disclosed herein;

FIG. 10 is an illustration of another embodiment of an interface for creating synchronized interactive content with multimedia in accordance with the subject matter disclosed herein;

FIG. 11 is a schematic flow chart diagram illustrating an embodiment of a method for displaying synchronized interactive content with multimedia on a mobile device in accordance with the subject matter disclosed herein;

FIG. 12 is an illustration of one embodiment of an interface with an embedded experience in accordance with the subject matter disclosed herein;

FIG. 13 is an illustration of another embodiment of an interface with an embedded experience in accordance with the subject matter disclosed herein;

FIG. 14 is an illustration of yet another embodiment of an interface with an embedded experience in accordance with the subject matter disclosed herein;

FIG. 15A is an illustration of an embodiment using a QR code reader in accordance with the subject matter disclosed herein;

FIG. 15B is an illustration of an embodiment using text messages in accordance with the subject matter disclosed herein;

FIG. 16 is an illustration of an embodiment of a branching graph in accordance with the subject matter disclosed herein;

FIG. 17 is an illustration of an embodiment of the system on a mobile device in accordance with the subject matter disclosed herein; and

FIG. 18 is a schematic flow chart diagram illustrating an embodiment of a method for trigger-based content presentation in accordance with the subject matter disclosed herein.

### DETAILED DESCRIPTION

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireline, optical fiber, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. The computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

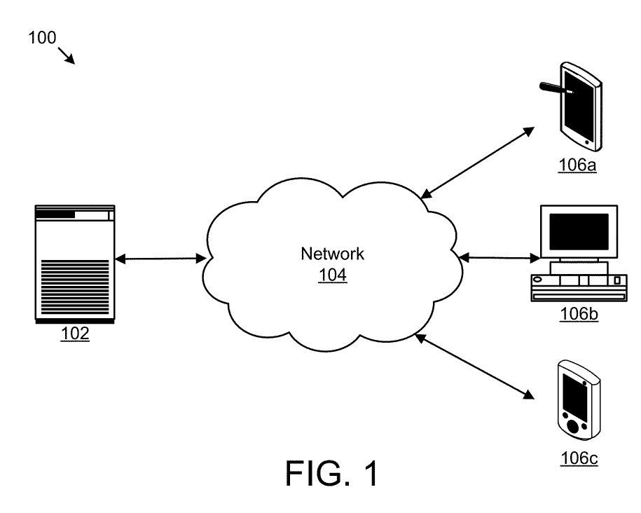

FIG. 1 is a schematic block diagram illustrating one embodiment of a system 100 for synchronizing interactive content with multimedia. In the depicted embodiment, the system 100 includes a server 102, a network 104, and a plurality of client devices 106. As used herein, the server may also be configured as a mainframe computer, a blade center comprising multiple blades, a desktop computer, and the like. Although for simplicity one server 102, one network 104, and three clients 106 are shown, any number of servers 102, networks 104, and clients 106 may be employed. One of skill in the art will also readily recognize that the system 100 could include other devices such as routers, printers, scanners, and the like.

The server 102, in one embodiment, may include memory storing computer readable programs and may include a processor that executes the computer readable programs as is well known to those skilled in the art. The computer readable programs may be tangibly stored in storage in communication with the server. The server may host, store, and/or provide a multimedia element synchronized with one or more interactive content elements for access and/or download over the network 104 by the plurality of clients 106.

The network 104 may comprise a global communications network such as the internet, a Local Area Network (“LAN”), multiple LANs communicating over the internet, a wide area network (“WAN”), a cellular network, or any other similar communications network. The network 104 may include hardware such as routers, switches, cabling, and other communication hardware. Each client 106 may be embodied as a desktop computer, a portable computer, a server, a mainframe computer, a handheld computing device, a touch device, a personal desktop assistant (“PDA”), a tablet computer, an eBook reader, a mobile phone, a smart phone, a smart TV, a kiosk, a head-mounted display, smart eyeglasses, smart contact lenses, and the like.

Each client 106 may communicate with the server 102 through the network 104. In one embodiment, a client 106 communicates with the server 102 by way of a program executing on the client 106, such as an internet browser or an application configured to access and/or download multimedia content from the server 102, as is known in the art. In one embodiment, the server 102 may distribute one or more interactive content elements synchronized with a multimedia element such as video, graphics, sound, and text, which may be accessible to the client devices 106 over the network 104. In certain embodiments, the program on the client device 106 allows a user to interact with the multimedia element and/or the one or more interactive content elements by using an input device. The input device may include a mouse, stylus, joystick, controller, and the like. One of skill in the art will recognize other ways for a user to interact with a client device 106.

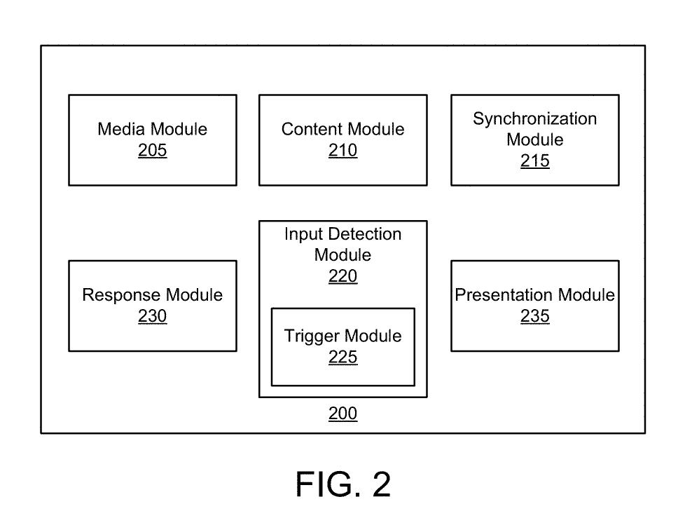

FIG. 2 is a schematic block diagram illustrating one embodiment of an apparatus 200 for synchronizing interactive content with multimedia. The apparatus 200 includes a media module 205, a content module 210, a synchronization module, 215, an input detection module 220, a trigger module 225, a response module 230, and a presentation module 235, which are described below.

The media module 205, in one embodiment, displays one or more multimedia elements. As used herein, multimedia may be media content that uses various different content forms, such as text, audio, images, graphics, video, slideshows, animations, documents, interactive presentations, demos, pitches, and the like. The one or more multimedia elements, in some embodiments, may include, but is not limited to, pre-recorded and/or live-streaming media (e.g., live-streaming content from a social media web site), timed or untimed media, or the like. In other embodiments, the one or more multimedia elements may include presentations created by a presentation program such as Microsoft PowerPoint, Apple's Keynote, and the like.

The media module 205 may present the multimedia content by visually displaying the content on an electronic display of a client device 106. In certain embodiments, the content is presented using a media player 402 capable of multimedia playback, as illustrated in FIG. 4. The media player 402 may be integrated into a client program, such as an internet browser, or may be a standalone application, such as Windows Media Player or QuickTime.

Referring now to FIG. 2, the media module 205 may access a remote server 102 through the network 104 to download a multimedia element for playback in the media player 402. Alternatively, the media module 205, in some embodiments, may access multimedia elements stored on a local computer. For example, the media module 205 may reside on a mobile device that may have one or more multimedia elements stored on the device. The media module 205, in another embodiment, may access live-streaming media from the internet, a television provider, a radio provider, and/or the like, for playback in the media player 402.

The content module 210, in one embodiment, presents one or more interactive content elements associated with the multimedia element displayed by the media module 205. The one or more interactive content elements may include, but is not limited to, text content, audible content, and/or visual content. Text content may include text, audible content may include spoken words, music, sound effects, and/or the like, and visual content may include images, video, graphics, animations, slideshows, presentations, and/or the like.

The content module 210, in one embodiment, displays visual content by presenting the one or more interactive content elements on an electronic display. A user may interact with the one or more interactive content elements displayed by the content module 210 through an input device such as a mouse, stylus, joystick, controller, and/or the like. For example, a user may view interactive content presented on the display of a touch screen device and use a finger and/or stylus to interact with the content.

The one or more interactive content elements displayed by the content module 210, in one embodiment, may include hyperlinked text, graphics, images, buttons, and/or the like. In other embodiments, the one or more interactive content elements may include, but is not limited to, survey questions, polls, quizzes, games, assessments, evaluations, hot spots, and/or the like. As used herein, hot spots may include interactive locations overlaying a multimedia element which allow user interaction. In another embodiment, an interactive content element may include a custom HTML overlay, which presents interactive objects for a user to interact with by, for example, clicking with a mouse, hovering over with a mouse, selecting with a finger, and/or the like. The interactive objects within the custom HTML overlay may link to external locations, such as websites, and/or display different interactive content elements. In further embodiments, the one or more interactive content elements displayed by the content module 210 may overlay the multimedia presented in the media player 402 by the media module 205. In certain embodiments, the one or more interactive content elements may be displayed pre-roll and/or post-roll. For example, a user watching an online video on YouTube® may be presented with one or more survey questions before the video starts and/or after the video is completed.

In yet another embodiment, the media module 205 may embed the media player 402 in a client application, such as an internet browser, by using an embed link encoded in a programming language, such as HTML, PHP, and/or the like. In one embodiment, the “iframe” HTML tag may be removed from the embed code to allow one or more interactive content elements to be integrated into the media player 402. By removing the “iframe” HTML tag from the embed code, the one or more interactive content elements may be discoverable by a web crawler, such as Google®, Yahoo!®, Bing®, and/or the like, which allows the content to be indexed and ranked for search engine optimization (“SEO”).

The synchronization module 215 synchronizes the presentation of the one or more interactive content elements displayed by the content module 210 with a multimedia element displayed by the media module 205. In one embodiment, as the multimedia element is playing in a media player, the synchronization module 215 may update the one or more interactive content elements in response to the segment of the multimedia element being presented.

For example, as shown in the embodiment depicted in FIG. 4, a video 412 may be configured to present a user with a question 406 every ten seconds during playback of the video 412 in the media player 402. In this example, the synchronization module 215 may pause the media player 402, present the user with a question 406 that has been prepared beforehand, and wait until the user has answered the question to continue playing the video. In other embodiments, the synchronization module 215 may update other areas of the display 404, 408, 410 that present one or more interactive content elements in response to the current position of the multimedia element being presented.

In a further example, a live-streaming television program may be playing in the media player 402. Intermittently during the live-streaming program, commercial advertisements may be shown that present to the viewer products, services, information, and/or the like. The commercial advertisements, as part of the live-streaming television program, may be synchronized with one or more interactive content elements, such as poll questions, survey questions, trivia questions, quiz questions, and/or the like, which a viewer can interact with in real-time while watching the commercial advertisements. In one embodiment, a viewer watching the live-streaming television program on a television set may interact with the one or more interactive content elements by using an internet connected set-top box such as Google® TV, Apple® TV, and the like. In another embodiment, the live-streaming program, with its one or more synchronized interactive content elements, may be viewed and interacted with in real-time on an internet connected client device 106, such as a “smart TV,” computer, mobile device, and/or the like and/or saved for offline viewing on a digital video recorder (“DVR”), computer, mobile device, and/or the like.

In one embodiment, a mobile device and/or smart phone, such as an iPhone or Android-based phone, may host the media module 205 and the content module 210, which are configured to effectively utilize the limited viewing area of the mobile device screen. For example, in one embodiment, a video may be presented on the mobile device by the media module 225. The video may be paused by the content module 210 when an interactive content element, e.g., a survey question, is presented to the user. In some embodiments, the video may be hidden by the media module 205 in order to dedicate the viewing area to the content module 210. In another embodiment, the content module 210 may overlay interactive content elements over the video. The video may reappear, in some embodiments, and continue playback after the user has interacted with the interactive content.

Referring back to FIG. 2, in another embodiment, the synchronization module 215 may employ “question logic” where the synchronization module 215 updates the one or more interactive content elements and/or the multimedia element based on user input. For example, referring again to the embodiment depicted in FIG. 4, survey questions 406 may be synchronized with a video 412 playing in the media player 402. The synchronization module 215 may update the video 412 playing in the media player 402 with a different video in response to a user's answer to a survey question 406. Moreover, a user's answer to the questions 406 may determine how the one or more interactive content elements and/or the multimedia element are updated. In this manner, a content creator may use the synchronization module 215 to customize the interactive and/or multimedia content in real-time by chaining together various content elements, such as videos, graphics, text, and the like, in response to user input.

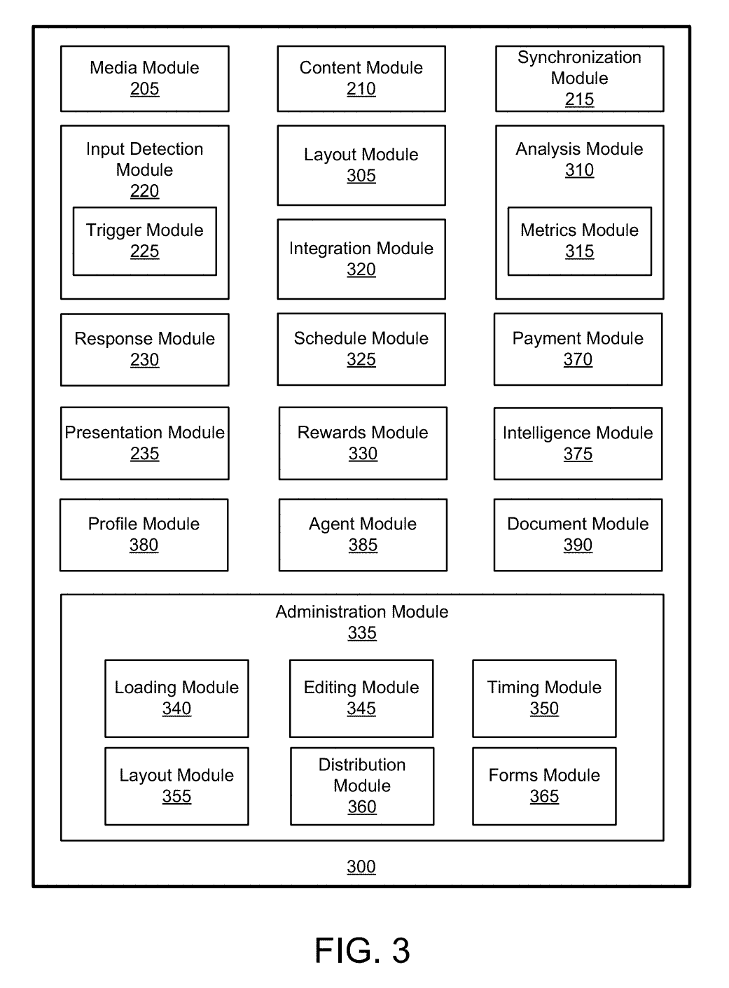

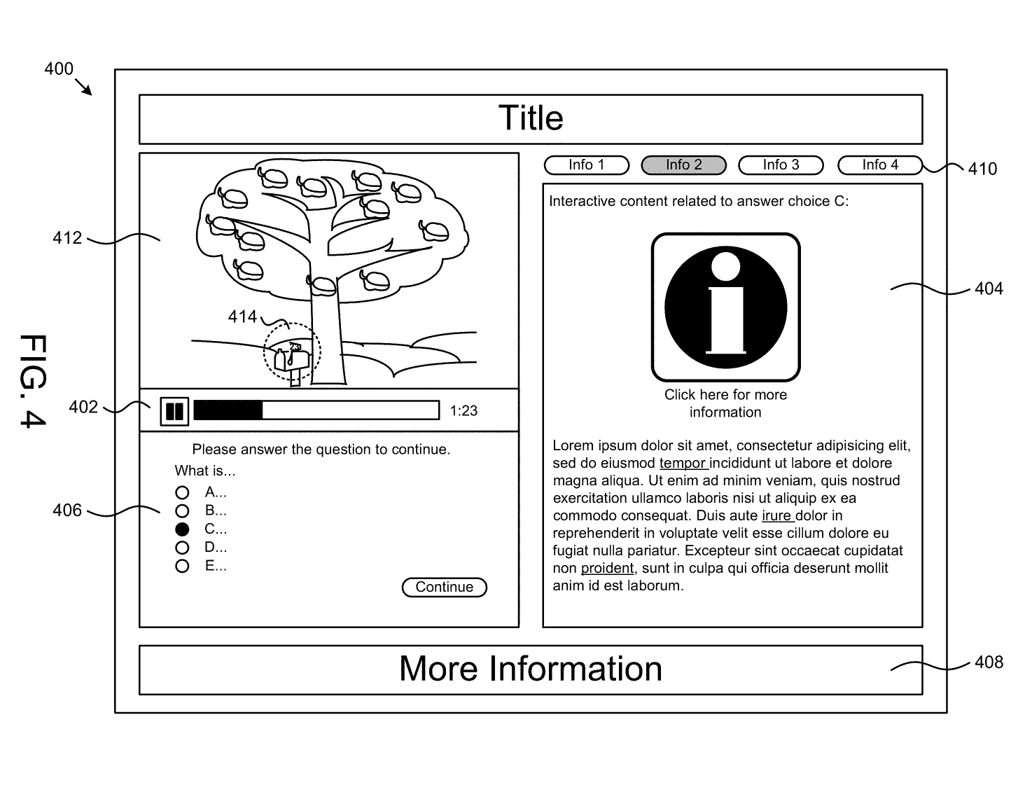

In one embodiment, the administration module 335, described below with reference to FIG. 3, allows a content creator to upload one or more multimedia elements and link them together based on a user's feedback provided to the interactive content elements. For example, a content creator may upload a series of videos and link different videos to different answer choices for a multiple choice survey question. The user's responses will determine which of the uploaded videos will be displayed. Similarly, in other embodiments, the content creator may link different interactive content elements to different responses provided by the user. In this way, the content creator may design a complex marketing scheme based on the user's responses, which would provide a different experience for each user.

In another embodiment, a content creator may design a response-driven decision making project, such as for an advertising campaign, a real estate project, a business deal, or the like, which would include one or more interactive multimedia content elements. For example, a user may be unsure about the direction to go regarding an advertising campaign for an upcoming product. To help the user solve this problem, the user is presented with a response-driven decision making project that initially presents the user with one or more general advertising options. In one embodiment, a user may be presented with a sample video and asked a series of questions regarding items, ideas, expressions, people, music, and/or the like displayed in the video in order to get a sense of what the user likes and the direction the user wants to go with the advertising campaign. Alternatively, the questions may be designed to determine where to advertise, i.e., social networks, websites, television, radio, and the like, the market to target with the advertising, when to advertise, or the like. In response to the user's responses to the initial questions, a subsequent video may be displayed with more specific questions, and so on. The response-driven decision making project incorporates “question logic” to determine, based on the user's answers, what interactive multimedia content to display next.

Alternatively, for example, a real estate company may have a number of videos that are used for their advertising campaigns. A real estate broker may be presented with one or more questions to determine the type of client the broker is targeting, i.e., questions regarding age, marital status, housing preferences, or the like. Based on the broker's answers, one or more possible advertising campaigns may be displayed that the broker can choose from. In other embodiments, another series of questions may be presented to the broker to help get more specific information from the broker. The broker may additionally select various customized options for the advertising campaign, such as music, video clips, taglines, or the like, which are presented to the broker based on the broker's responses. The broker may then choose where to distribute the selected advertising campaign, such as on a website, social network, mobile network, or the like. Moreover, the broker may choose to share the advertising campaign with just a single client, a group of clients, or an entire community.

In a similar example, a CEO may be struggling with a tough business decision, such as a possible merger, long term investment options, expansion options, or the like. The CEO may be presented with an initial questionnaire, which would create a baseline and drive the next set of questions based on the CEO's responses. The questionnaire may incorporate multimedia elements, such as photographs, audio tracks, videos, or the like. Subsequent questionnaires may include more specific questions based on the CEO's responses to the previous set of questions. The questions may drill down into specific information regarding the CEO's company, such as costs, expenses, forecasts, revenues, profits, assets, and/or the like, in order to provide more specific results and/or options to help the CEO make an informed decision.

Referring now to FIG. 2, the input detection module 220, in one embodiment, detects input from a user interacting with one or more of the interactive content elements, as described above. The input device may include a mouse, a stylus, and the like. One of skill in the art will recognize other ways for a user to interact with a client computing device. In other embodiments, the input detection module 220 includes a trigger module 225 that performs an action in response to input detected by the input detection module 220.

The trigger module 225, in one embodiment, detects a triggering event. As used herein, a triggering event comprises an action, an event, a signal, or the like that triggers a corresponding action, event, and/or response. For example, the triggering module 225 may be located on a user's mobile device and may detect signals, input, receive data, or the like from one or more sensors of the user's mobile device. In response to the detected triggering event, the triggering module 225 may perform an action, a series of actions, produce another triggering event, and/or the like. The triggering module 225, in some embodiments, is located on a device communicatively coupled to one or more mobile devices, one or more sensors, one or more other devices (e.g., appliances, televisions, set-top boxes, gaming systems, security systems, or the like), or the like, and may detect a triggering event from the one or more mobile devices, the one or more sensors, the one or more other devices, or the like. In such an embodiment, the trigger module 225 is part of a device that is connected to a system that may be known as the “Internet of Things.” As is known in the art, the “Internet of Things” refers to the internetworking of physical devices, vehicles (also referred to as “connected devices” and “smart devices”), buildings, and other items—embedded with electronics, software, sensors, actuators, and network connectivity that enable these objects to collect and exchange data.

In one embodiment, the trigger module 225 detects a triggering event in response to a user interacting with one or more interactive content elements. The trigger module 225 may perform an action in response to a user interacting with an interactive content element. The action, in certain embodiments, may include, but is not limited to, displaying a website and/or updating the one or more interactive content elements associated with the multimedia element, such as displaying questions, updating advertisements, updating informative text, and the like. For example, in one embodiment, the trigger module 225 may open a website when a user interacts with hyperlinked text.

Other triggers may include, but are not limited to, input received from one or more sensors such as data associated with motions, gestures, finger prints, eye movements, hand movements, smells/odors, simulated taste, accelerometer movements, gyroscopic movements, color vision, proximity sensors, binocular vision, acoustics, voice commands, images, or the like. For example, the trigger module 225 may receive audio input that includes a person talking about a particular car. In response to the audio input, the trigger module 225 may present, or cause to be presented, interactive content associated with the car, other cars, car accessories, car insurance, and/or the like. In other embodiments, the trigger module 225 may respond to motions, gestures, and/or voice commands by live and/or inanimate objects, such as computers, robotic devices, or the like. Other triggers may include external signs and/or symbols, which may be either physical or digital, such as a sign on TV or in a video.

In another embodiment, interactive content presented on a display, such as questions, advertisements, and the like, may be updated by the trigger module 225 in response to a user interacting with an interactive content element. For example, in one embodiment, a user may click on an answer to a survey question 406 overlaying a video 412 playing in a media player 402, as depicted in FIG. 4. The trigger module 225, in response to the user's answer to the survey question 406, may update the one or more interactive content elements 404, 408, 410 associated with the survey question.

In another example embodiment, synchronized interactive content may overlay the video 412 in the form of a video hot-spot 414, which a user may click on to gain more information about the object in the video 412. The trigger module 225 may perform an action associated with the hot-spot, such as updating the one or more interactive content elements 404, 408, 410 and/or opening a website associated with the object. In other embodiments, a user's eye movements may be tracked as he views the multimedia content, which may trigger customized interactive content to be displayed in response to where the user is looking. For example, a user may be viewing a music video and as he looks at different objects within the video, such as clothing, automobiles, musical instruments, and the like, the trigger module 225 may display interactive content associated with those objects. In some embodiments, similar to tracking eye movements, speech and/or gesture inputs may be processed by the trigger module 225 to perform an associated action.

Referring back to FIG. 2, in yet another embodiment, the trigger module 225 may detect an external and/or internal cue and may perform an action in response to the external and/or internal cue. An external cue may include signals transmitted from an object or a device (e.g., a three-dimensional printer, a virtual reality device, an augmented reality device, robots, drones, various devices in an “Internet of Things” environment, devices with artificial intelligence engines, and/or the like) that may be used as an interaction device to trigger an action by the trigger module 225. For example, a user may be wearing a pair of running shoes which have an embedded transmitter configured to trigger an action by the trigger module 225 when connected to the embodied apparatus. The transmitter within the user's shoes may communicate specific information about the shoes to the trigger module 225 as it relates to the multimedia content being viewed by the user. If a user is viewing a running video, for example, the transmitter may communicate to the system the user's shoe size, the type of shoe, how long the user has been wearing the shoes, and the like. In this manner, the system may generate real-time interactive content, such as survey questions, polls, advertisements, and the like, customized to the user's preferences and lifestyle.

In another example embodiment, the trigger module 225 may receive input from another device, such as a wireless beacon, a smart phone, a tablet computer, a fitness band, a radio-frequency identification (“RFID”) chips or tags, or the like, and may present interactive content to the user in response to the received input. For example, the trigger module 225 may receive input from a smart television associated with a television program that the user is watching. In response to the input, the trigger module 225 may present, or cause to be presented, interactive content associated with the program the user is watching, associated with one or more sponsors of the televised content, associated with the television itself, and/or the like.

In yet another example embodiment, the trigger module 225 may receive input from a fitness band, such as a Fitbit®. The input may include the type of exercise the user was performing, where the user was exercising, the weather conditions while the user was exercising, and so on. Based on the input, the trigger module 225 may present, or cause to be presented, interactive content associated with the user's exercise, such as gym memberships, workout equipment, workout clothing, weather forecasts, upcoming exercise schedules, recommended exercises, exercise videos, exercise-related articles, and/or the like.

In one embodiment, the trigger module 225 detects a triggering event based on a user's and/or a device's location. For example, a geolocation system, such as a global positioning system (“GPS”) system, may trigger an action by the trigger module 225. The trigger module 225 may collect location information from a user in order to generate one or more custom interactive content elements based on the user's location. For example, as a user walks into a retail store, he may be presented on his mobile device with a video of a store employee welcoming him into the store. The video may present the user with real-time interactive questions regarding the purpose of the user's visit in order to help him find products in the store, provide information about products located within the user's proximity in the store, provide offers, coupons, rewards, or the like associated with products in the store located proximate to the user's location, and/or the like. In another embodiment, a user may have interactive multimedia delivered to their smart device while they are waiting in line, such as at a grocery store, airport, hotel, or the like, which may be determined by a GPS system. In other embodiments, interactive multimedia content is delivered to a user's smart device while they are on hold during a telephone call, a conference call, a chat, or the like.

In some embodiments, the trigger module 225 located on a server may receive the user's location in the store from a GPS system. The trigger module 225 may then query a database for multimedia and interactive content based on the user's location in the store and send this information back to the user through the network 104. The multimedia content may be a video that recommends products and/or presents product reviews. Alternatively, the user may be presented with customized rewards while in the store, such as offers and promotions, for performing reward-based actions in the store, as described below. In other embodiments, the user's location may be dynamically tracked as the user moves through the store, triggering interactive content, such as coupons, product reviews, and the like, based on the user's location.

In another embodiment, trigger module 225 detects a triggering event based on the time of day, day of the week, time period, a calendar event, and/or the like. For example, the trigger module 225 may detect a triggering event in response to determining that it is a Saturday morning. As described below, based on the triggering event, various content may be presented to the user, such as videos, advertisements, quizzes, etc. to determine what the user usually does on Saturdays, to provide recommendations, offers, coupons, suggestions, or the like to the user to attract the user to various events, attractions, stores, or the like on Saturday, and/or the like.

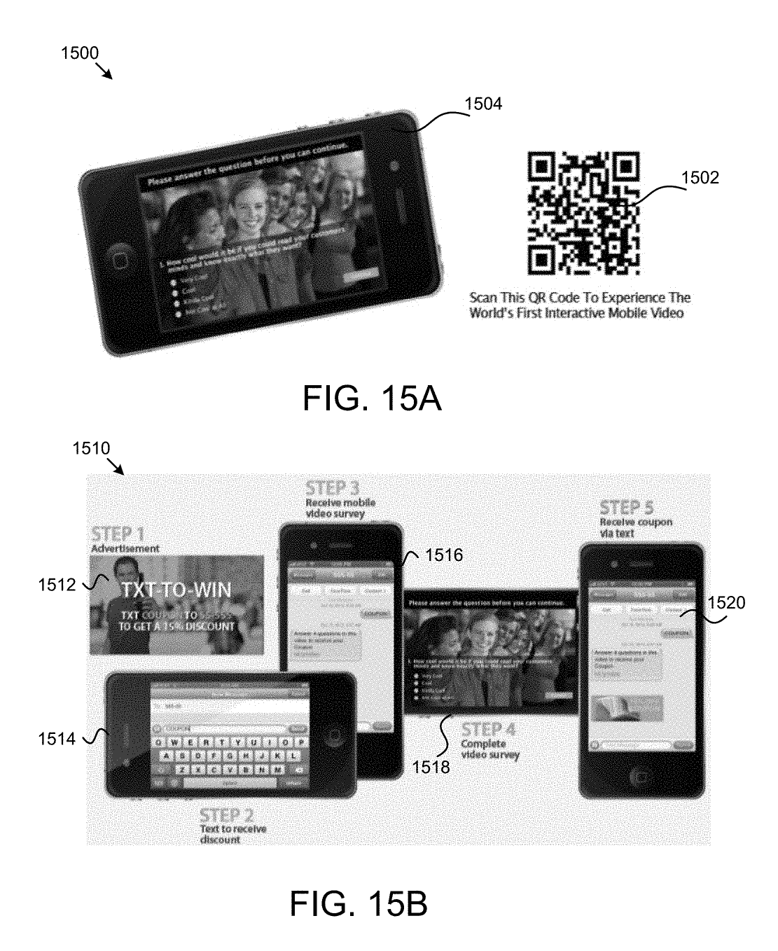

In another embodiment, the trigger module 225 may receive an electronic message from a user to trigger an action. The electronic message may include a text message, an email message, a digital voice message, or the like. In one example, as illustrated in FIG. 15B, a store may post an advertisement 1512 that says, “Text COUPON to 55555 to get 15% off of your purchase.” In response to the user texting 1514 the word “COUPON” to the specified number on their mobile/smart device, the trigger module 225 sends a reply message 1516. The reply message may include interactive multimedia content 1518, such as a video, quiz, survey, game, or the like. In another embodiment, the reply message includes a link to the interactive multimedia content. In order to receive the discount, the user would have to playback the multimedia content and perform some action associated with the interactive content elements, such as answer survey questions, fill-out a lead capture form, play a game, or the like. The user would then be sent a coupon 1520, via an electronic message, to use in the store.

In another embodiment, the trigger module 225 may trigger an action in response to a user scanning a quick-response (“QR”) code 1502 with a device capable of reading QR codes, such as a smart phone or tablet, as illustrated in FIG. 15A. In yet another embodiment, the trigger module 225 may trigger an action in response to a “near field” communication (“NFC”) request. One of skill in the art will recognize other technologies, in light of the present subject matter, that act as a bridge between static marketing content and an electronic device. For example, a user may scan a QR code 1502 printed on an advertisement promoting a discount at a retail store, a hotel, a sporting event, an airport, or the like. In response to scanning the QR code, the trigger module 225 sends an interactive multimedia element, such as a video survey, via a text message and/or email message to the smart device 1504. The user may then receive a promotional incentive in response to playing the multimedia content and providing one or more responses to the one or more interactive content elements.

Referring to FIG. 2, in one embodiment, the trigger module 225 may update the one or more interactive content elements in response to audible words associated with a multimedia element. For example, a user may be presented with a video displaying an automobile advertisement. The advertisement may include a narrator that audibly describes the various features of the automobile while images or videos of the features are displayed. The trigger module 225 may update the one or more interactive content elements in response to cues from the narrator's spoken words. Thus, as the narrator describes the interior options on different models, for example, the trigger module 225 may update the one or more interactive content elements to display text and/or images describing the different interior options in response to an audible cue, such as the word “interior,” as spoken by the narrator.

In yet another embodiment, the trigger module 225 may present multimedia and/or interactive content elements on a device in response to a product being purchased with said device. For example, mobile devices, such as smart phones, may be used to purchase items at a point of sale by scanning a code and/or device, using “near field” communication between devices, and/or the like, which may debit a user's account or apply the balance to a credit card. The trigger module 225, in response to a product purchased in this manner, may present to the user multimedia and/or interactive content, such as survey questions, rewards, and/or the like (e.g., a “thank-you” video from the store accompanied with coupons which may be applied to future visits). In another example, a user may be watching a commercial advertisement on a smart TV. The smart TV may allow the user to use a device, such as a smart phone or tablet computer, to communicate with the TV to purchase the product. Again, in response to the purchase, the trigger module 225, may present multimedia with synchronized interactive content to the client device used to purchase the product. In other embodiments, a user may be presented with related products and/or services from a partner vender, in response to a purchase. The affiliated partner may then be provided with data regarding the purchase, such as referral information from the consumer, by the trigger module 225.

In one embodiment, the trigger module 225 sends a signal to one or more external devices in response to user input, which may include direct input (e.g., a touch input, a mouse-click input, or the like) or indirect input (e.g., eye or facial tracking, audio input, location input, or the like). For example, a user may be presented with a survey associated with a video clip on the user's device. In response to the user's responses to the survey, the trigger module 225 may send the responses, data related to the user, data associated with the video clip that the user viewed, and/or the like, to an external device, such as a server, a smart phone, a smart television, or other communicatively coupled device. In response to receiving the data, the external device, or a trigger module 225 located on the external device, may perform an action such as sending additional content elements to present to the user on the user's device, sending coupons/offers/rewards/etc. to the user on the user's device, displaying additional information/advertisements/etc. on the user's device or on a display of another device (e.g., an in-store display unit, a billboard, or the like), and/or the like. In this manner, the trigger module 225 can communicate with one or more other devices 102, over a network connection 106, to receive and send data based on user's responses and other triggering events.

In some embodiments, the user may submit a search query, a question, or the like to a browser, an application, or the like, which the trigger module 225 may detect. The trigger module 225 may take the question, for example, and forward it to an external device, to the response module 230, or the like to determine a content element to present to the user that is associated with the question.

In one embodiment, the response module 230 determines a content element to present to a user in response to the triggering event that the trigger module 225 detects. The content element, as described above, includes a multimedia element and one or more interactive content elements that are synchronized with the multimedia element such that the interactive content elements are presented at predetermined points during presentation of the multimedia element.

For example, if the trigger module 225 detects a triggering event that is triggered based on the user's location, or the location of the user's device, the response module 320 may determine a localized content element to present to the user. The localized content element may include a video advertisement for a local restaurant, a push notification on the user's device, a coupon or offer for a local retail store, or the like. The response module 230 may receive the content from a local data store, a cloud device, a local network device (e.g., a device in a retail store, a restaurant, or the like).

In one embodiment, the presentation module 235 presents the content that the response module 230 determines or receives. The content may be displayed on a user's device and/or on an external device. For example, the presentation module 235 may present the content on the user's smart phone, fitness band, tablet computer, desktop computer, or the like. The presentation module 235 may additionally, or alternatively, present the content on an external device such as a smart television, a smart refrigerator, a retail display, a display in a vehicle, a billboard, or the like.

In this manner, the apparatus 200 can initiate or direct “conversations” between devices, e.g., device to device communication; a user initiating a conversation with a device; and/or a device initiating a conversation with a user based on the triggering mechanisms that the trigger module 225 detects and acts upon to present interactive content to a user, and use a plurality of various devices to facilitate targeted content presentation and feedback.

FIG. 3 depicts another embodiment of an apparatus 300 for synchronizing one or more interactive content elements with a multimedia element. The description of the apparatus 300 refers to elements of FIGS. 1 and 2, like numbers referring to like elements. The depicted apparatus 300 includes a media module 205, a content module 210, a synchronization module 215, an input detection module 220, and a trigger module 225, wherein these modules may be substantially similar to the like numbered modules in FIG. 2. Further, the apparatus 300 includes a layout module 305, an analysis module 310, which includes a metrics module 315, an integration module 320, a schedule module 325, a rewards module 330, a payment module 370, an intelligence module 375, a profile module 380, an agent module 385, and a document module 390, which are described in more detail below.

In some embodiments, the apparatus 300 may include an administration module 335. The administration module 335 includes a loading module 340, an editing module 345, a timing module 350, a layout module 355, a distribution module 360, and a forms module 365. The apparatus 300 as depicted may be implemented in various industries including, but not limited to, government, medical, health care, commercial, retail and gaming. The embodied apparatus 300 may also be integrated into several systems, such as training, e-learning, assessment, catalogue, presentation, entertainment, point of sale, e-commerce, advertising, hiring, customer service, customer support, and/or the like. In other embodiments, the apparatus 300 may be located on various systems in a myriad of industries, including, but not limited to, financial services, venture funding, crowd funding, health care, emergency services, and/or the like. In other embodiments, the apparatus 300 may be integrated into chat services, such as instant messenger, Skype, AIM, and/or the like.

Moreover, while the depicted embodiment includes the above listed modules, in certain embodiments, the apparatus 300 may include a subset of the depicted modules alone and/or in various combinations.

In one embodiment, the layout module 305 positions the multimedia element displayed by the media module 205 and the one or more interactive content elements displayed by the content module 210 on a display. In certain embodiments, the one or more interactive content elements displayed by the content module 210 may be displayed proximate the multimedia element displayed by the media module 205, which may be above, below, left, and/or right in relation to the position of the multimedia element. In another embodiment, the layout module 305 may overlay the one or more interactive content elements over the multimedia element being displayed by the media module 205. The layout module 305, in other embodiments, may display the one or more interactive content elements displayed by the content module 210 both proximate and overlaying the multimedia element displayed by the media module 210.

The analysis module 310 collects data, in real time, online or offline, in response to user input detected by the input detection module 220. The data collected by the analysis module 310 may be stored in a database on a local server or remotely in a cloud computing environment, such as Amazon's Simple Storage Service (“S3”). The analysis module 310, in one embodiment, may use the collected data to provide the user with real-time customized analysis, evaluations, recommendations, reports, and the like, in response to the user's interaction with the one or more interactive content elements. Various statistical analyses may be performed on the data including cross tabulations, optimization analyses, pattern analyses, tracking analyses, business intelligence analyses, and/or the like. In certain embodiments, where the one or more interactive content elements include questions, the analysis performed by the analysis module 310 may be performed on a per question basis and/or for the entire question set.

For example, in one embodiment, a user may view a training and/or assessment video displayed by the media module 205 with associated interactive questions displayed by the content module 210. The interactive questions may be synchronized with the video by the synchronization module 215 so that the questions are shown at predetermined segments of the video. At the end of the video, the user may be presented with an overall score and/or an evaluation report created by the analysis module 310 describing the performance for each question. The analysis module 310 may produce various score reports, comparative score reports to illustrate how the user performed compared to other users, custom reports based on data fields or other information that the user selects to view, and/or the like. In some embodiments, the analysis module 310 may produce certifications such that a user may become certified in a certain subject, earn badges and/or achievements, earn points, and/or the like, if the user answers a predetermined number of questions correctly during playback of the training and/or assessment video.

In another example, a user may purchase an online training course that includes multimedia content with synchronized interactive content. The user would be given a username and password, which would allow access to a dedicated membership site containing their training/certification videos, quizzes, surveys, and/or the like. The user would view the training videos and answer the assessment questions as they are presented before, during, and/or after the video. Their answer history, progress, and contact information would be tracked and analyzed by the analysis module 310 to determine when the user achieved a successful pass rate and when to move the user on to more difficult certification trainings.

A similar example would be in a commercial setting where a user is presented with a video and is asked to compare products, rank products, provide reviews, or the like, regarding products displayed in the video. At the end of the video, in one embodiment, the user may be given a list of recommendations created by the analysis module 310 in response to the user's answers to the questions presented during the video. In certain embodiments, the analysis module 310 may display different forms of multimedia and/or interactive content within the generated reports and recommendations, such as video, audio, text, and the like.

In one embodiment, the data that the analysis module 310 tracks, collects, stores, and/or the like includes data used to capture micro moments, micro commitments, and other micro data. As used herein, micro data refers to data used to describe a user's interaction with hundreds or thousands of real-time, intent-driven experiences, especially on mobile devices. The data, which may be captured in an affinity database, may be used to gain insights into a user's preferences, habits, trends, etc., to customize content for pre-targeting, targeting, and/or re-targeting users, on a per-user basis, based on previous micro moments or micro commitments. The data may also be used for marketing, advertising, sales, lead production, lead nurturing, lead scoring, and/or the like.

For example, an interactive content element may be presented to a user via an automated sales chat bot (provided by the agent module 385, described below). The sales chat bot may capture lead-related data from the user, e.g., micro data associated with the user, and send the data to an integrated CRM, which may be configured to process the micro data, e.g., Salesforce Insights®. The lead information may then be forwarded to a face-to-face sales channel so that a person can follow-up with the user. In another example, the interactive content element may be electronically presented to multiple users, a group of users, an organization, or the like to capture collaborated micro data that describes the group, each member in the group, a subset of members in the group, and/or the like. The analysis module 310, for example, may collect micro data from a group video chat, a multiplayer game, or the like, which may include the same content or different content presented in real time or delayed for later presentation. In this manner, the interactive content element, presented based on various triggers, acts as a micro-data or lead data capture channel. The data may then be used for market research, business intelligence, advertising, sales, targeting, or the like.

In another embodiment, the analysis module 310 assigns cookies to the user based on their responses to the interactive content elements, such as their answers to survey questions or product reviews. Third party websites and applications may use the cookies to provide targeted advertising, marketing promotions, offers, discounts, and the like, to the user based on their responses. For example, based on a user's positive product review of a mountain bike found in a cookie assigned to the user, Google would provide advertising directed toward mountain bikes and accessories related to the product that received the positive review in their search results when the user performed a Google search.

In one embodiment, the analysis module 310 uses pixel tracking, i.e., “pixeling” to track users by associating a clear graphics file, e.g., a GIF, with a content element, e.g., on a webpage, within a mobile app, or the like. The analysis module 310 may derive general information from the user's computer's cookies and use the data to track the user's purchasing habits, for example. For example, the pixels may communicate with cookies on a device and pull information from those cookies, such as the name of the campaign that resulted in a click-through or the date of a sale. The information that the analysis module derives may be used for pre-targeting, targeting, or re-targeting content to the user.

In some embodiments, the analysis module 310 may integrate with, communicate with, or the like marketing services such as social marketing services (e.g., Facebook Audience Insights®) using pixel tracking embedded within a user's social media content. The marketing services may provide various anonymous and non-anonymous information and insights to the analysis module 310, which may be used to pre-target, target, or re-target content elements, based on the various triggers discussed above, to a particular user.

In other embodiments, the analysis module 310 processes pre- and post-purchase data, including feedback provided by the user and purchasing behavior. In one embodiment, purchase data may be accessed by scanning a QR code printed on a receipt. The QR code, in some embodiments, may contain metadata associated with the recent purchase, such as a receipt identifier, store identifier, the UPC codes of the items purchased, or the like. Scanning the QR code located on the receipt, in other embodiments, may deliver interactive multimedia content to the user's device, such as a website, text message, or the like, that is specific to the store where the receipt was printed. The analysis module 310, in one embodiment, may use the receipt metadata to track the purchasing behavior of the user and analyze the collected data, in addition to the data generated by the user's responses to the interactive content, such as a survey, quiz, game, or the like. The user, in other embodiments, may have a tag associated with their membership account, such that the user's tag may be sent to external systems associated with the membership site. For example, when a user successfully completes a training module, the user's tag may be forwarded to automated marketing sites, customer relationship management systems, and/or similar systems to provide personalized content for the user.

In other embodiments, the analysis module 310 provides artificial intelligence learning capabilities. In one embodiment, the analysis module 310 learns by analyzing responses to an interactive multimedia provided by a user. The analysis module 310 may then intelligently respond to the user with more personalized interactive multimedia content, such as targeted video surveys, quizzes, polls, assessments, games, product suggestions, and the like. Further, based on an analysis of the provided responses, more personalized rewards, incentives, offers, promotions, or the like, may be presented to a user in response to the user completing a survey, quiz, poll, or the like. In one embodiment, the analysis module 310 continually refines and adjusts the content of the responses provided to a user based on the user's responses to the interactive content.

The analysis module 310, in some embodiments, may include a metrics module 315. The metrics module 315 may further analyze the data collected by the analysis module 310 to generate one or more multimedia metrics, audience metrics, brand metrics, and the like. Multimedia metrics may include the number of views, viewed minutes, completion rates, social shares, click-through rates, ad-clicks, and the like. Audience metrics may include a number of demographic statistics, such as the number of unique viewers, age, gender, marital status, and the like. Brand metrics may include statistics associated with products such as brand awareness, favorability, purchase intent, recall, and the like.

In other embodiments, psychographic metrics may be collected, including, but not limited to, personality, attitudes, values, interests, lifestyles, and the like. In certain embodiments, an interactive content element may include a sentiment meter, which may be configured to gauge a user's feelings and/or emotions at certain points during playback of a multimedia element, as would be recognized by one skilled in the art. For example, a sentiment meter may be used to collect emotional data from a user regarding products in a video. Alternatively, a sentiment meter may be used to assess how an audience feels at different points during a business pitch. This would provide a content creator with real-time behavioral and emotional feedback and/or metrics.

In another embodiment, the metrics module 315 may provide a dashboard interface summarizing the various statistics and metrics collected. The interface may include pie charts, bar charts, line graphs, matrixes, tables, and the like that graphically depict one or more metrics generated by the metrics module 315. The various metrics may be provided to interested parties, such as content creators, advertisers, affiliates, and/or the like. In one embodiment, the metrics module 315 may include an export function that exports the collected metrics, or a subset of the collected metrics, to different file formats, such as a comma-separated values file (“CSV”), a portable document format file (“PDF”), and the like, to be used by other applications, such as a spreadsheet program, a statistical package program, and the like. One of skill in the art will recognize various file formats which may be used for exporting data.

In one embodiment, the apparatus 300 may include an integration module 320. The integration module 320 integrates the data collected and stored by the analysis module 310 with external applications such as customer relationship management (“CRM”) systems, e-commerce systems, statistical software packages, email systems, marketing systems, and the like. In another embodiment, the integration module 320 tags, filters, and/or segments, in real-time, collected data that may be pushed to external systems. For example, an external CRM system may have an automated marketing response function that will automatically send a text message, email, and/or the like based on a tag. The tag may be a customizable keyword or term associated with a piece of information. The CRM system may be integrated into the embodied system by the integration module 320, which may send the CRM system data collected from the embodied system with its associated tags. The CRM system, upon receiving the data, and its associated tags, may trigger one or more automated marketing responses. In another example, upon receipt of a user's tag, a user's membership site may be customized with new content and/or features.

In a further example, a content creator may want to send a “thank-you” email to any person who watches a video. The integration module 320 may tag the user, based on metrics collected by the metrics module 315, and an external email system may receive the data and/or tag in real-time. The email system, based on the data and tag received, can customize the email message, recommend products, provide product promotions, and/or the like to send to the user. Further, in some embodiments, the external system may include a short message service (“SMS”) system, an e-commerce system, and/or other external systems that include automated marketing response functions.

Some embodiments of the apparatus 300 may also include a rewards module 330. The rewards module 330 may provide loyalty points, incentives, discounts, coupons, badges, achievements, bargains, promotions, offers, and the like for a user's participation in a survey, poll, quiz, game, assessment, training, and the like. The rewards module 330 may customize the rewards offered in response to a user's interaction with the one or more interactive content elements. For example, in one embodiment, a retailer may present to a user a video with synchronized interactive survey questions regarding the products in the video. As a user answers the questions, the analysis module 310 may use the answers as a reference to find products in a product database in order to create customized product recommendations in real-time.

In another example embodiment, a user may play an online game or a game app on a mobile device that may include taking pictures or videos as part of the game. The pictures or videos may be shared with other users who may be watching the game. The other users may guess, bet, select, or the like what the next move for the user playing the game may be. The other users may provide input by selecting interactive content elements presented to the user, such as a poll, a list of possible bet amounts, or the like. Users may watch a chess game that has already been played, for example, and prior to each move, the users may select and/or bet on what they think the next move may be. In another example, users may be watching a chess game that is being live-streamed, and may chat, predict moves for the players, bet on moves, or the like by interacting with different interactive content elements that are presented while the chess game is live-streamed. The rewards module 330 may provide various coupons, offers, rewards, badges, achievements, etc., for winning users, e.g., users who correctly predict moves, select correct answers etc.

Alternatively, the rewards module 330, using the information gathered from the analysis module 310, may generate customized product promotions and/or coupons. The rewards module 330, in various embodiments, may use the demographic and/or psychographic metrics collected by the metrics module 315 to offer a user customized rewards based on variables such as a user's interests, activities, opinions, age, gender, and the like. The customized rewards may include, but are not limited to, loyalty points, frequent flyer points, coupons, gift certificates, promotions, and the like based.

In other embodiments, the rewards module 330 may provide rewards for a user's participation in rewards-based actions, such as providing an email address, buying a product, repeating a purchase, reviewing products, recommending products, advertising products, and the like. For example, a user in a retail store may be provided with coupons and/or promotions based on the user's location in the store. A GPS system may be used to determine the user's location relative to products displayed in the store. As a user approaches rewards-eligible products, the rewards module 360 may present to the user, on a client device 106 such as a mobile device, smart phone, and the like, one or more rewards for performing an action associated with the product, such as purchasing the product, writing a review, advertising the product, and the like.

In yet another embodiment, a schedule module 325 may be provided to schedule playback of the one or more interactive content elements synchronized with the multimedia element. In one embodiment, for example, an entrepreneur may be trying to collect investment capital using crowd funding. The entrepreneur creates a webinar video with interactive content that may be available online for viewing. A potential investor may schedule a more convenient time to watch the video in return for registering their name, phone, email address, and the like, with the website.

The schedule module 325, in one embodiment, also allows the potential investor to set an alert telling the system to remind him about the webinar before the scheduled time. In other embodiments, the schedule module 325 may also allow the user to invite others to the webinar through their social media site (e.g., Facebook “friends”), email invitations, or the like. The webinar video may be synchronized with the same types of interactive content discussed above, which provides more interactivity and data collection than would be provided with traditional webinar systems. In this manner, a user is able to reach a large number of people with their pitch, while also gaining valuable real-time feedback through the user's interaction with the synchronized interactive content.

Certain embodiments of the apparatus 300 may also include an administration module 335. The administration module 335 provides an interface that allows a content creator to create user-generated content by loading and/or segmenting a multimedia element, editing one or more interactive content elements, and synchronizing the one or more interactive content elements with the one or more segments of the multimedia element. The administration module 335 provides a streamlined content creation interface such that a content creator does not have to switch between windows, interfaces, and the like in order to load, edit, and synchronize the one or more interactive content elements with the multimedia element.

In some embodiments, multiple users may register as content creators, create accounts for, pay fees to use, or the like to collaborate or work together to create an interactive content experience, e.g., working together to select or create multimedia elements, interactive content elements, video branching and playback order, and/or the like, via a web application, a mobile application, and/or the like. In one embodiment, multiple users may collaborate over group instant messaging, group chat, video conference, text or SMS messaging, email, and/or the like.

In one embodiment, each multimedia element and/or interactive content element may be embodied as a tile, card, block, badge, or the like so that a content creator can drag-and-drop a tiles to create various content elements. For example, a content creator may drag a tile representing a predefined survey or questionnaire onto a video or image. Similarly, a tile may represent a predefined combination of a multimedia element and interactive content elements. In one embodiment, a user may reuse, store, save, or the like previously created content elements, e.g., a video with various questionnaires or surveys interlaced within the video, as a tile, and may reuse the tile for various advertisements, offers, trailers, highlights, or the like. Tiles may be combined with other tiles, edited, or the like.

In one embodiment, the administration module 335 creates an account associated with a content creator such that a content creator may need to provide credentials, such as a username and/or password, to login to their account. The administration module 335, in other embodiments, associates preferences, uploaded content, created content, or the like, with the content creator's account.

In some embodiments, the administration module 335, is located on a mobile device, such as a smart phone, and is formatted to be easily used on the mobile device. Thus, any of the modules associated with the administration module 335, such as the loading module 340, editing module 345, layout module 355, distribution module 360, and/or the like. In some embodiments, the content creator, using the administration module 335, has the ability to create multimedia content on a mobile device, such as capturing video on a smart phone, adding interactive content to the multimedia content (e.g., surveys, polls, quizzes, or the like), syncing the interacting content to the multimedia content, and distributing the multimedia and interactive content (e.g., by sending a hyperlink, sharing on a social network, sending an email, sending an SMS, or the like). In this manner, a content creator may easily create and share interactive multimedia content from almost anywhere using a mobile device.

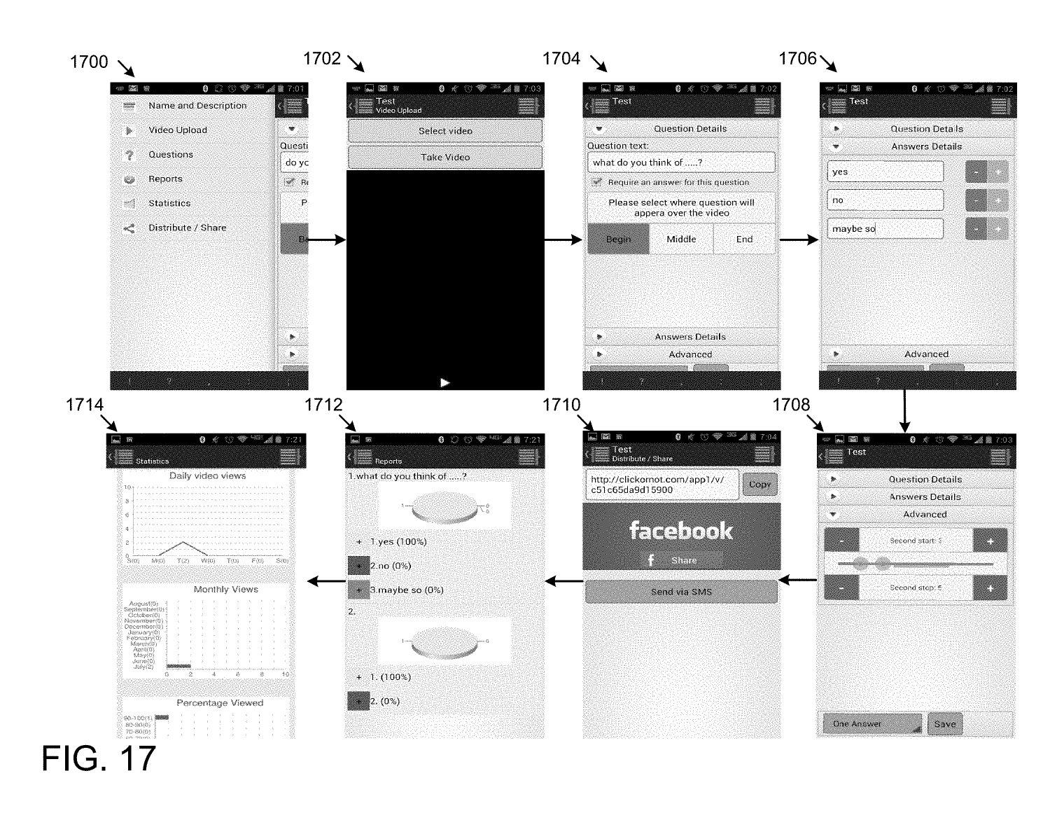

In one embodiment on a mobile device, as depicted in FIG. 17, the administration module 335 presents a menu 1700 of content creation options to the content creator. The content creator may select (e.g., by touching with a finger) to upload a video and/or image, or capture a video and/or image, using a multimedia loading interface 1702 presented by the loading module 340. The content creator may also create interactive content, such as creating one or more questions using a question creation interface 1704, creating one or more answers associated with the questions using an answer creation interface 1706 and syncing the interactive content with the multimedia content using a syncing interface 1708. A distribution module 360, described below, may distribute the interactive multimedia content to one or more destinations selected by the content creator on a distribution interface 1710, such as one or more social networks, text message recipients, email recipients, or the like. In another embodiment, the content creator may view reports on a reporting interface 1712 and/or statistics on an analytics interface 1714.

The loading module 340 loads a multimedia element, such as a video, presentation, slideshow, audio file, and the like, into a media player capable of multimedia playback. In one embodiment, the multimedia element may be uploaded to a server where the administration module 335 is located. Alternatively, the loading module 340 may load a multimedia element hosted on a media website such as YouTube, or on a cloud server such as Amazon's® S3 service. The loading module 340, in some embodiments, divides the multimedia element into one or more media segments.

In one embodiment, the loading module 340 loads multiple multimedia elements that may be used, for example, for video branching or “question logic” as described above. Video branching, as used herein, allows the content creator to string together multiple video clips, slides, images, documents, or the like based on a user's responses. For example, the content creator may ask a question with three possible responses, each associated with a different video clip based on the user's selection. Video branching may also refer to linking the user's responses to different points within a single video clip, slideshow, or the like. For example, a multimedia content element has video clips targeted for female and male users, a questionnaire may be presented before the video is presented asking the user for the user's sex. Based on the user's response, the appropriate video clips, e.g., the male or female clips, will be presented to the user, without displaying the video clips intended for the opposite sex.

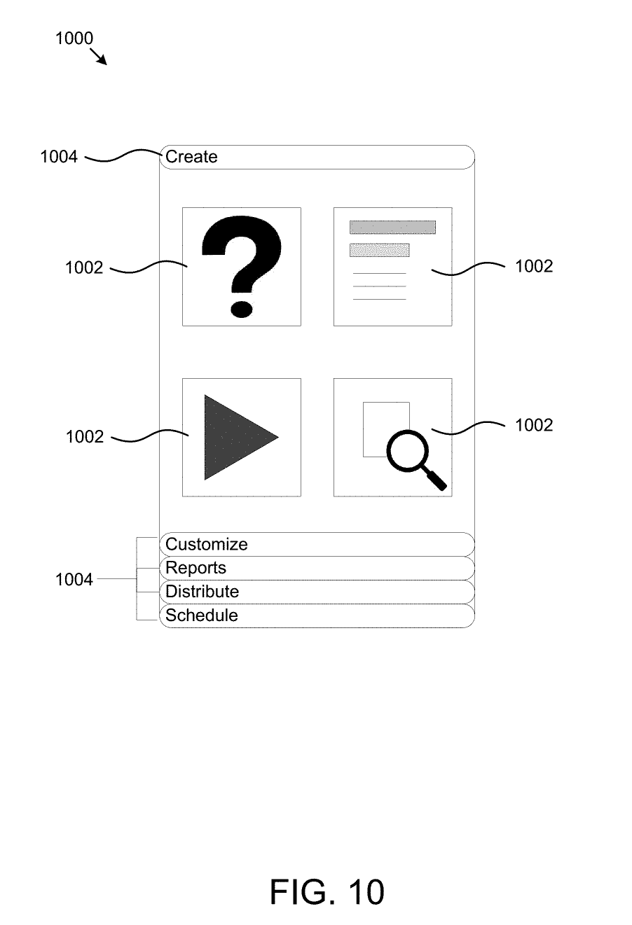

The editing module 345 provides a content toolkit 1000, as shown in the embodiment depicted in FIG. 10, which allows a content creator to create and/or edit one or more interactive content elements. In one embodiment, the toolkit 1000 includes one or more customization tools 1002 which allow the content creator to customize the one or more interactive content elements associated with the multimedia element. The one or more customization tools 1002 in the toolkit 1000, in some embodiments, may be arranged in categories 1004, where each category 1004 contains similar customization tools 1002. In certain embodiments, the categories 1004 of the content toolkit 1000 may be arranged in an accordion such that each category may expand and collapse in response to user input, showing and/or hiding the one or more customization tools at the same time.

For example, in one embodiment, the content toolkit 1000 may include categories 1004 such as “Create,” “Customize,” “Distribute,” and “Reports.” The “Create” category may be expanded, displaying the one or more customization tools 1002 within the category, where each tool is represented by an icon. The content creator may then click on the “Reports” category, which would expand the category to display the one or more reporting tools, while at the same time collapsing the “Create” category. In some embodiments, all the categories 1004 may be expanded to display all the available customization tools 1002. Alternatively, only one category 1004 may be expanded at a time while the other categories 1004 remain collapsed until interacted with by the user.

Referring back to FIG. 3, the timing module 350 synchronizes the one of more interactive content elements with the one or more segments of the multimedia element. In certain embodiments, the timing module 350 provides an interface with a timeline component that may synchronize one or more interactive content elements with the one or more segments of the multimedia element. The timeline component, in some embodiments, assigns the position and/or duration of the one or more interactive content elements associated with the multimedia element.

For example, as shown in the embodiment depicted in FIG. 9, a content creator may link to a video hosted on YouTube®. The loading module 340 may load the video 904 into a media player capable of multimedia playback 902. The loading module 340 may also divide the video into one or more segments. The content creator may create a plurality of multiple choice survey questions 906, using the editing module 345. The multiple choice survey questions 906 may be synchronized with different segments of the video 904 and displayed during playback of the video 904. After loading the video 904 and creating one or more survey questions 906, the content creator uses the timing module 350, with its associated timeline component 908, to assign the survey questions 906 to one or more segments in the video 904, setting when the survey questions 906 will be displayed and for how long (e.g., Question 1 will be displayed after the video has been playing for 25 seconds and will be displayed for 5 seconds).

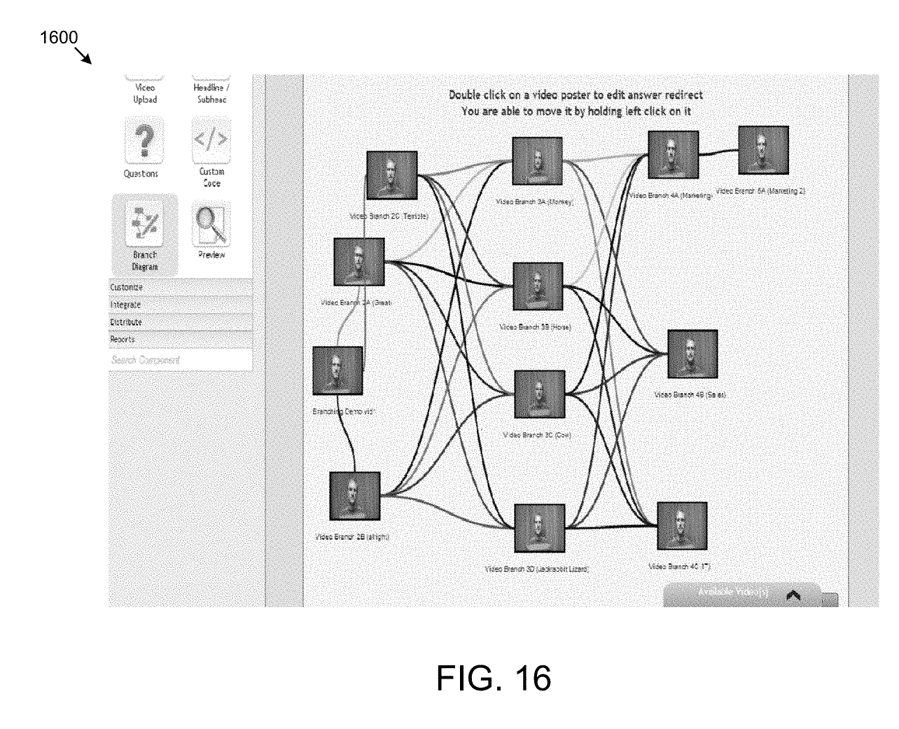

In some embodiments, the content creator may utilize video branching to link 910 the video (or any other multimedia element like slides, images, documents, etc.) to a different video based on the user's responses. In one embodiment, the content creator may also link to position within the same video. As shown in the branching graph 1600 of FIG. 16, the content creator may create many multimedia paths for a user to go through based on the user's responses. In one embodiment, the editing module 345 displays the branching graph 1600 to provide a quick overview of the multimedia branching provided in their interactive multimedia project. In the depicted embodiment, a plurality of video clips is linked together based on the user's responses. The branching graph 1600, in some embodiments, is interactive, which allows the content creator to edit the links and change the order of the multimedia branching. In certain embodiments, the video path selected by a user may be saved, such that a final video incorporating the selected video clips may be shared with others by, for example, a social network, SMS, email, and/or the like.

Similar to video branching, user's responses to the interactive content elements may branch to different interactive content elements. For example, a user who selects answer A on a questionnaire may be presented with a new question that is different than the question that may have been presented if the user had selected answer choice B, C, D, or the like. In another example, each content element, e.g., each video clip, may be associated with, located on, inserted into, or the like a “page,” e.g., a web page, that also includes different advertisements, offers, promotions, or the like that are associated with the content element. Similar to the branching above, the different pages may be linked based on the user's responses or interactions with the multimedia or interactive content elements.

In another embodiment, the editing module 345 creates multimedia content, such as videos, audio tracks, slideshows, chat bots, wish lists (for presenting to various users and receiving the users' feedback, suggestions, recommendations, etc.), and the like. In a further embodiment, the editing module 345 creates a video from static content uploaded by a content creator, such as one or more photographs, documents, and the like. In one embodiment, the editing module 345 provides screen capture capabilities such that a content creator may record a series of screen shots from a computer interface. For example, a content creator may create a tutorial for using a software product by recording a series of computer interface screen shots demonstrating the product being used. In another embodiment, the content creator may add audio tracks, voice over tracks, or the like, to the created multimedia content. As with multimedia content that is uploaded, interactive content elements, such as survey questions, call to action buttons, hot spots, lead capture forms, and/or the like, may be added to and synchronized with the created content.

In one embodiment, the editing module 345 creates a community feedback service, e.g., a crowdsourcing service, where a user may solicit feedback from one or more persons by overlaying one or more questions, a poll, a quiz, or the like, on a multimedia content element. For example, a user shopping for a shirt in a clothing store may want to ask his friends whether he should buy the green shirt or the blue shirt. The user may take a picture of both shirts with his smart phone and overlay questions that he creates, such as “Should I buy the blue or green one?” The user, in one embodiment, sends the picture with the interactive content elements to one or more of his friends. In another embodiment, he posts the interactive multimedia content on his social network. The user may select which users may see the picture, e.g., social media friends, family, other contacts, everyone (public), or the like. In a further embodiment, the user creates a poll to determine how many people think he should buy the green or the blue shirt. The results of the poll may be kept private, may be shown to selected users, e.g., particular social media contacts, may be shown to everyone in real time, and/or the like. Alternatively, companies may use this to gain feedback regarding packaging, product design, or the like. For example, a company may post one or more pictures or videos, with surveys, polls, or the like, overlaying the content to solicit feedback from one or more persons.

The editing module 345, in yet another embodiment, creates an interactive video blog that can incorporate user reviews and be shared on various social networks. For example, a user may create a video blog covering a recent visit to a restaurant. The user may create one or more interactive content elements, such as a survey, poll, open-ended questions, or the like, and synchronize the interactive content with the video review. The video blog and the users' responses to the interactive content elements, in one embodiment, may be shared on one or more social sites, such as Yelp®, Facebook®, YouTube®, or the like. Similarly, a user may create a video blog of a product and incorporate interactive content to gain other's feedback regarding the product. In one embodiment, the feedback collected is posted on the site where the product was purchased, such as Amazon®, or on a similar site where the product is listed for sale.

In another embodiment, the editing module 345 receives voice commands and/or input from the content creator. For example, a content creator may create a series of survey questions, quiz questions, assessments, and/or the like using voice input. The editing module 345 may receive the voice input and use voice recognition software to translate the voice input into text. Similarly, the editing module 345 allows a content creator to select an option to receive voice input from a user when a user interacts with an interactive content element. For example, a user may respond vocally to a survey question, instead of typing an answer or clicking on an answer choice, if the content creator has selected a voice input option.

In certain embodiments, the editing module 345 may also be used by the content creator to produce static interactive content elements that may not necessarily be synchronized with the multimedia element, such as advertisements, social media links, external website links, and the like. In other embodiments, the editing module 345 creates incentives, such as coupons, offers, discounts, or the like, and may assign the created incentives to a multimedia element loaded by the loading module 340. For example, a content creator may customize a coupon for a 15% discount in a store and choose a distribution method, such as SMS/text message, email, social media, digital voice, or the like. Thus, as described above, a user may receive the coupon if he replies using the distribution method of choice, such as text message, views the multimedia content, and responds to the interactive content elements.

In some embodiments, the editing module 345 creates incentives based on a user's loyalty point program, frequent flyer program, or other type of loyalty program. In one embodiment, a content creator may select an option to provide a loyalty program incentive by allowing a user to connect to the user's loyalty program such that after a user interacts with the interactive multimedia content, the user may enter their loyalty program credentials to receive the offered promotion. In another embodiment, the content creator may select a predefined keyword to be assigned to the incentive, such as “coupon,” “discount,” or the like, which the user would need to use in their electronic message to receive the discount.

The editing module 345, in some embodiments, may create batch coupon codes, which a content creator may use for their user incentives. In other embodiments, the content creator may upload a list of pre-generated coupon codes, which may be used at any time during content creation. The coupon codes, which may be any type of code associated with a discount, offer, bonus, or the like, may be created as one-time use codes or as multiple use codes. One-time use codes, as the name suggests, may only be used once and are then invalidated and/or removed from the system. Multiple use codes may be used multiple times by a single user, or shared with many users. In some embodiments, multiple use codes may be assigned a limit of how many times the code may be used.

The editing module 345 may create interactive games based on multimedia and interactive content, as provided by the content creator. The games may be multiplayer or single-player. The games may include watching a multimedia content and answering one or more questions (or providing other feedback or responses) associated with the content to earn the next clue, rewards, points, level-ups, in-app content, downloadable content, or the like. For example, a company may create a “game” by asking users to take photos or videos at various locations and of various objects and provide recommendations, suggestions, ratings, rankings, etc., in return for some payment, reward, gift card, offer, promotion, discount, of the like. In a particular embodiment, Wal-Mart® may run a marketing campaign for consumers to take images of videos of product placement within the stores and provide feedback or other content associated with the captured video or images.

The editing module 345 may create auctions based on multimedia and interactive content, as provided by the content creator. For example, the user may upload one or more images or videos of items for sale and provide interactive content for each image that includes fields where users can enter bid amounts, where users can elect to “buy-it-now,” where users can ask questions, provide feedback, or the like. A content creator may also present items to inquire users for the value of the items, such as a house or a car, over a period of time, and then post the items for auction. The administration module 335 may process orders associated with an auction or direct the buyers/sellers to a clearing house, or the like, for a fee. The analysis module 310 may collect and track user information, such as bid amounts, items that were bid on, demographic or contact information, or the like, which may be used later, e.g., by the intelligence module 375 described below, to direct or present content to the user.

In one embodiment, the administration module 335 may also include a layout module 355. The layout module 355 positions the media player capable of media playback, the content toolkit, and the timeline component of the timing module 350 proximate each other within a single window. This type of layout provides a streamlined interface such that a content creator does not have to switch contexts between windows and/or other interfaces in order to load, edit, and synchronize the one or more interactive content elements with the multimedia element.

The distribution module 360 distributes the one or more interactive content elements synchronized with the multimedia element to advertising affiliates and/or other third party platforms. For example, in one embodiment, a content creator loads a video, creates interactive content, and synchronizes the content with the video. The distribution module 360 distributes the content to advertising affiliates who may embed the video, together with the synchronized interactive content, on their website. In this manner, the content creator is able to gain more real-time feedback in response to a user interacting with the one or more interactive content elements than traditional advertising methods, such as banner-ads and email campaigns.

Further, in some embodiments, when the video is interacted with by a user, the affiliate may gain an affiliate commission and/or credit. In one embodiment, the embedded code used to display the multimedia content may include the affiliate's identifier and/or an affiliate code in order to trace any interactivity with the multimedia content to the affiliate. The affiliate, in certain embodiments, may receive credits, commissions, or the like, in response to users playing the multimedia content on the affiliate's site, making a purchase associated with the multimedia content, interacting with the interactive content elements, and/or the like.

In some embodiments, the multimedia element and its synchronized interactive content elements may be stored on a server. The distribution module 360, in one embodiment, may share with affiliates an embed link for the multimedia element and its synchronized interactive content elements. In this manner, all the affiliates are linking to the same content stored on the server, which may allow changes and/or updates to the multimedia element and/or the one or more interactive content elements to be distributed in real-time among affiliates that may use the embedded content.

For example, in one embodiment, a product video may be loaded by a retailer. The retailer may place an interactive “Buy Now” button at the end of the video that a viewer may use to buy the product displayed in the video. The retailer stores the video on a server and shares an embed link with his advertising affiliates, who in turn display the video on their one or more websites. The retailer, however, would also like to add a “More Info” button that a viewer can use to get more information about the product. The retailer only has to add the button to the video stored on the server and all the videos displayed on affiliate websites using the embed link will be updated simultaneously in real-time.

The distribution module 360, in some embodiments, integrates the apparatus 300 with social media sites such as Facebook®, Twitter®, Google+®, and the like, providing the content creator with an effective tool to quickly share and promulgate content. In one embodiment, the distribution module 360 may post multimedia content, with its one or more synchronized interactive content elements, on a user's social media site. The one or more interactive content elements may include trivia questions, survey questions, polls, quizzes, games, and the like that may be used to gain real-time information from others in the user's social network who view the content on the user's social media site. In other embodiments, the distribution module 360 shares a user's customized recommendations, scores, evaluations, and the like in real-time on their social media site. The social media site allows the content to be shared by others in the user's social network, including the user's friends, friends of the user's friends, and so on, quickly promulgating the content.

For example, a user may share an e-learning video, which includes synchronized interactive content, on the “wall” of his Facebook page. The user's “friends” may watch the video on the user's “wall,” while simultaneously providing feedback and data in real-time by interacting with the interactive content. The user's “friends” may share the video with their friends by “liking” the video posted on the user's wall. The friends of the user's friends may also “like” the video, thus virally distributing the video through the user's social network. This viral promulgation may allow a content creator to produce brand awareness, product sales, and/or other marketing objectives through a self-replicating viral process. In other embodiments, the content may be distributed virally through interactive games, eBooks, images, text messages, and the like.

In one embodiment, the distribution module 360 distributes the multimedia content through “embedded experiences.” “Embedded experiences,” as used herein, are means to embed the services provided by a third party into a container on a social network website. For example, a user may share a YouTube video on their Twitter feed. YouTube may post a tweet about the video to the user's Twitter account. The tweet may contain an “embedded experience” where the user's Twitter followers may view the video from within Twitter without having to go to the YouTube website to watch the video. Further, an “embedded experience” may allow a user to perform other actions, such as sharing content, reviewing content, posting comments, or the like. The service providing the “embedded experience” may specify which features to make available to a user.

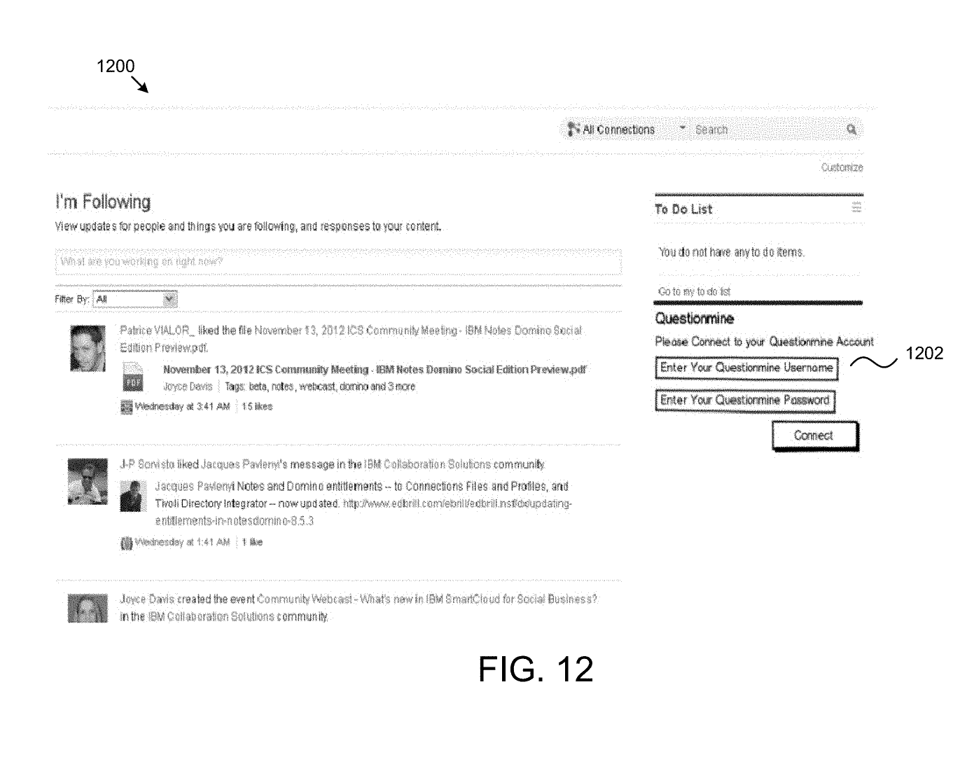

In some embodiments, the distribution module 360 provides an “embedded experience,” as illustrated in FIG. 12, where a user logs 1202 into their administration account from a social network website, such as Facebook, Twitter, or the like. In another embodiment, the “embedded experience” may be contained within an IBM® Connections webpage. IBM® Connections is a social software platform for organizations and enterprises. In one embodiment, the “embedded experience” may be embodied as an open social gadget and/or an iWidget. As used herein, the open social framework includes multiple application programming interfaces (“API”) that allow social software applications, such as an open social gadget or iWidget, to access data and core functionality on participating social networks. An open social gadget or iWidget may be developed in a web-based programming language, such as HTML, JavaScript, or the like.

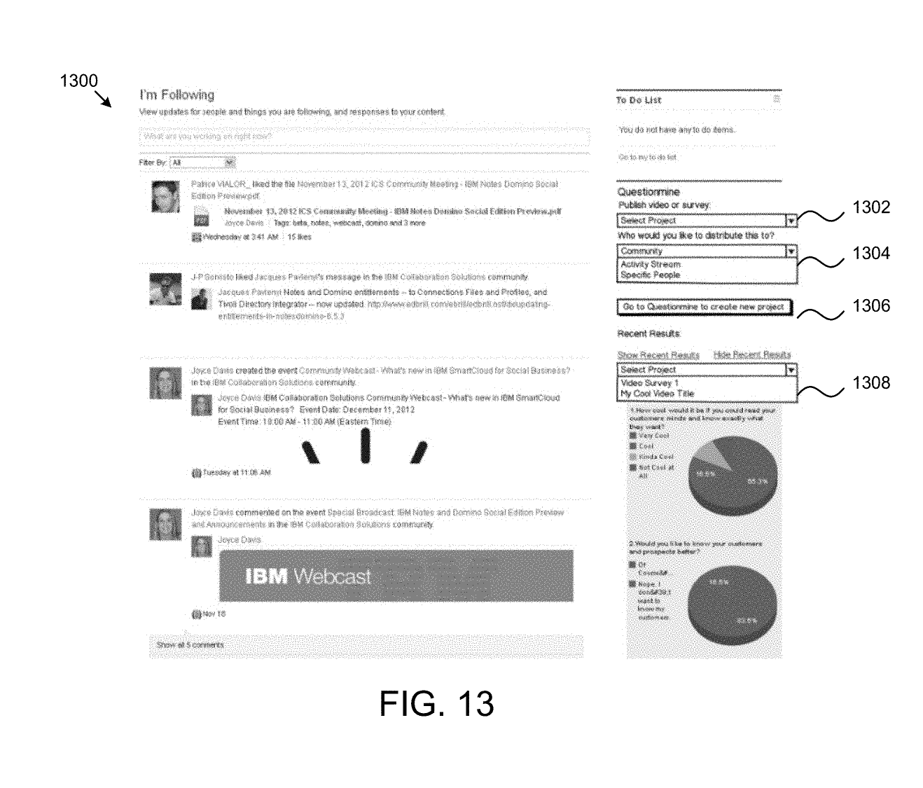

In one embodiment, as illustrated in FIG. 13, the user accessing his account through the “embedded experience,” after logging in to his account, may select 1302 a project to distribute to others on the social network where the “embedded experience” is being contained. The user, in a further embodiment, may select 1304 friends and/or contacts to share the project with. In some embodiments, the user may distribute the content to one or more specific persons, post the content in a general status update message, distribute the content to a specific group within an organization, and/or the like. For example, the user may distribute the content to the marketing department from their IBM® Connections account. In another embodiment, the user may access 1308 a snapshot of key metrics associated with the multimedia content shared through the “embedded experience” by selecting the appropriate project from a drop-down, or similar, menu within the “embedded experience” container. In other embodiments, the “embedded experience” container displays a link 1306 to the user's administrator account that, when clicked, takes the user to their administration account where the user may create more interactive multimedia content, view the full set of metrics, or the like.

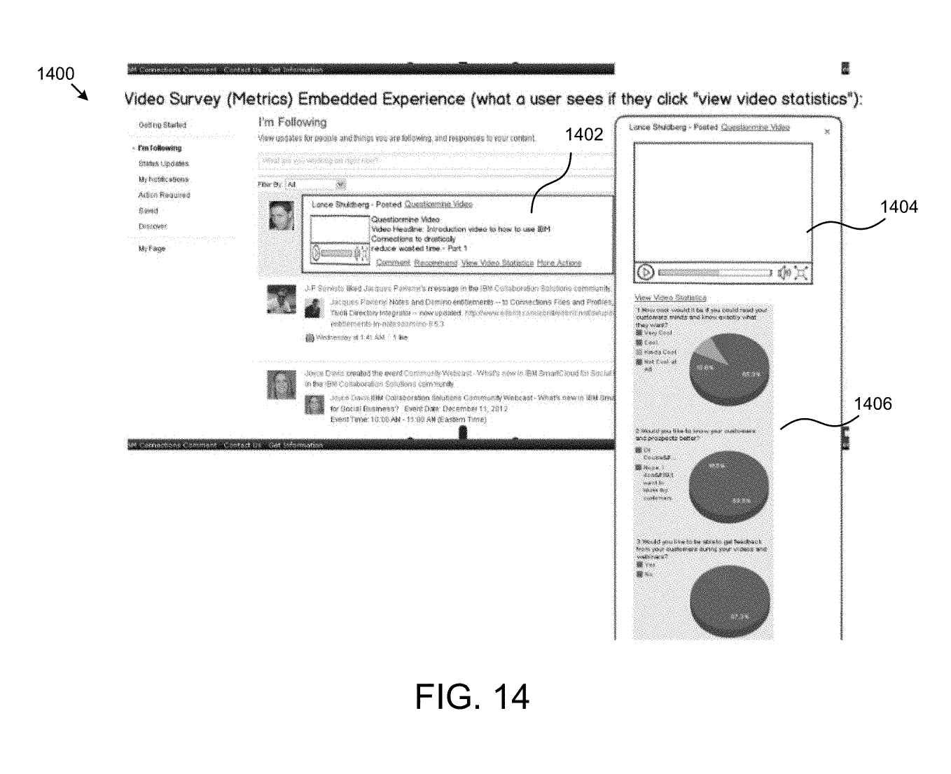

In another embodiment, the “embedded experience” may be a container for distributed interactive multimedia content. For example, as illustrated in FIG. 14, a video that is shared by a user on their IBM® Connections webpage 1402 may be displayed 1404 in an open social gadget and/or iWidget on the recipient's IBM® Connections webpage. In one embodiment, the “embedded experience” may be shared on a user's social activity stream, a user's social webpage, or the like. In another embodiment, the “embedded experience” may be sent to a user in an email and may be viewed within the body of the email. In yet another embodiment, the email may contain a link to the “embedded experience” that a user can click to take them to their social webpage to view the shared content. For example, a user may receive an email from IBM® Connections that says, “John Doe shared a video with you. Click here to view the video.” The video may be viewed either within the email itself or the recipient may click a link that takes them to their IBM® Connections webpage to view the video. The video may contain interactive content in accordance with this disclosure, such as surveys, quizzes, lead capture forms, or the like. In some embodiments, the recipient may be allowed to view 1406 responses and/or statistics of all previous viewers of the content within the “embedded experience” container. In one embodiment, the responses of previous viewers are not viewable by the recipient unless the user sharing the content specifies that the recipient may view the responses of previous viewers.

Referring to FIG. 3, in another embodiment, the distribution module 360 may send the multimedia element synchronized with one or more interactive content elements directly to a mobile device, such as a smart phone, in response to a scanned “quick response” (“QR”) code. The QR code may be printed on any direct mail piece, such as brochures, print advertisements, newspapers, and the like, or may be found posted in stores or other places. For example, a user may use a smart phone to scan a QR code associated with a product advertisement printed in a newspaper. The distribution module 360 may display a video and/or interactive content, such as survey questions, in response to the QR code being scanned. Alternatively, the distribution module 360 may display product offers, promotions, and/or other rewards created by the rewards module 330 in response to a scanned QR code. In other embodiments, the distribution module 360 may send interactive content, such as customer service surveys, to a device in response to a scanned sales receipt, a printed code manually entered by a user, a printed URL on a receipt, a URL in an SMS message, and/or the like.

In one embodiment, the distribution module 360 may be located on a device and may send the multimedia and interactive content elements to another device in response to a “near field” communication (“NFC”) request. For example, the distribution module 360 may be located on an iPhone which has synchronized multimedia and interactive content elements stored on the phone. An iPad may use an NFC request to request the multimedia and interactive content elements from the iPhone, which the distribution module 360 may then send to the iPad. In another example, a smart TV may send out NFC notifications to any proximate client devices 106 capable of receiving NFC communications. The distribution module 360 may then distribute content to any client devices 106 that respond to the NFC notification.

In another embodiment, the distribution module 360 distributes multimedia and interactive content elements to a crowd sourcing service, such as kickstarter.com, 99designs.com, and the like. For example, a user may create a video highlighting their products, goods, services, or the like to be evaluated by others. The video may show a series of products where after one product is shown, and before the product is displayed, an interactive survey appears requesting a viewer's opinions, reviews, comments, or the like, regarding the displayed product. The viewer, in order to view the remaining products in the video, would need to answer one or more survey questions to continue playback. In one embodiment, the content creator may offer a discount, prize, gift, or the like to incentivize the viewer to donate money to the content creator's project and/or obtain the viewer's feedback. In other embodiments, the content creator may request suggestions, ratings, up- or down-votes, rankings, or the like from a viewer and rank the results according to the most helpful suggestions. The content creator may offer prizes for first, second and third place, or the like.

In one embodiment, the distribution module 360 distributes multimedia and interactive content elements to photo sharing websites. In certain embodiments, the photo sharing websites contain static images, videos, and other dynamic content, such as animated gifs. In another embodiment, the photo sharing website includes a pinboard-style layout, such as pinterest.com, lockerz.com, or the like. The distribution module 360 may distribute interactive content elements to display with the multimedia content. For example, the photos may include hotspots, survey questions, or the like, associated with the displayed photos. The interactive content, in one embodiment, is not visible until the user rolls over the photos, for example, with a mouse or other input device.

In another embodiment, the distribution module 360 delivers multimedia with interactive content to gaming applications played on mobile devices, smart phones, consoles, interactive televisions, computers, or the like. Often, game developers provide “in-app” or “in-game” elements, such as “in-app” purchases or advertising, to try to incentivize a player to spend money, visit an advertiser's website, or the like. For example, a player may be required to spend money to “level up” or purchase the next stage of a game to continue playing. In one embodiment, the distribution module 360 distributes interactive multimedia content as the “in-app” element. For example, in order for a player to get to the next level or “level up,” he may be required to view a video and answer survey questions, take a quiz, fill out a lead form, or the like, associated with the video. In other embodiments, actions or events within the game would trigger the presentation of the “in-app” element. For example, an interactive video survey may be displayed when a player reaches a certain level, attains an achievement, or goes to a specific place within the game. Further, in addition to interactive videos, in other embodiments the distribution module 360 delivers interactive advertisements, sweepstakes, quizzes, and/or the like. In certain embodiments, the player's responses are collected and analyzed by the analysis module 310.

In other embodiments, a software application, such as a game, may include an augmented reality environment, such that the application includes a view of a real-world environment with elements that are augmented by computer-generated sensory input, such as audio, video, graphics, GPS, or the like. For example, a user walking down a street may be viewing the extent of the street in front of them through an application running on a mobile device. The application may augment the street view on the mobile device by adding computer generated elements, such as ratings for various restaurants on the street, offers and various retail stores on the street, points of interest, or the like. The distribution module 360, in one embodiment, distributes interactive media content to the application running on the smart device to augment the view of the street. Thus, for example, in order to receive a discount at a store on the street, the user would need to watch a product video and complete a questionnaire associated with the video. The coupon would then be sent via text, email, or the like, to the user in response to completing the questionnaire.

The administration module 335, in one embodiment, may also include a forms module 365 that may be used to create interactive forms incorporating various types of the above mentioned multimedia elements. For example, a content creator may want to display an opt-in form on their company website with an embedded video describing the company. The user may gain additional information about the company by disclosing on the opt-in form information such as the user's name, email address, and the like. In response to the user disclosing information on the opt-in form, the trigger module 225 may display additional multimedia and/or interactive content elements. The trigger module 225, in other embodiments, may respond by displaying a different website, sending an email, and/or the like. In another embodiment, the trigger module 225 sends real-time responses in response to receiving a completed form from a user, via email, text message, and/or the like, and based on the user's responses in the form. For example, if the user indicates on the form that he is a 25-year-old male, the trigger module 225 may determine one or more content elements targeted at men in the age group 25-34. In one embodiment, the trigger module 225 may use the rewards module 330 to offer the user incentives, offers, promotions, and the like in return for disclosing information on the opt-in form. Other types of forms may include various legal documents, contracts, agreements, records, and the like.

The payment module 370, in one embodiment, is configured to collect payments, produce invoices, and/or facilitate other financial transaction related activities in connection with a user's interaction with the multimedia element and/or the one or more interactive content elements. For example, a user may click on a product advertisement on a webpage to purchase the advertised product. Instead of being directed to the product seller's website, as in traditional systems, the user is presented with an interactive form created by the forms module 365 that allows the user to fill in their billing information and purchase the product from the current site. Alternatively, the payment module creates an invoice of the purchase for the user.

In other embodiments, the payment module 370 is configured to support micro-transactions, where items such as currency, loyalty points, achievements, and the like, can accumulate throughout the user interaction period, not only at a specific point of purchase. In some embodiments, the payment module 370 may provide a digital “shopping cart,” similar to most online retail stores, where a user can select one or more products during their interaction period to purchase in a single transaction when the user is finished. The payment module 370 may be configured to accept real currency, loyalty points, rewards points, and/or the like from the user to complete a transaction.

The intelligence module 375, in one embodiment, determines the content element that is presented to the user based on descriptive data associated with the user. In some embodiments, the descriptive data is selected from a user's profile (e.g., a social media profile, a shopping profile, or the like), an affinity database, and/or another data store that tracks and collects user data associated with the user's preferences, likes, dislikes, purchasing habits, and/or the like. An affinity database, as used herein, is a catalogue or collection of a user's tastes, likes, dislikes, preferences, habits, demographics, interests, shopping trends, or the like that are collected based on the user's past experiences, purchase history, order history, previous responses to interactive content, browsing history, content viewing history and habits, trends, and/or the like.

The intelligence module 375 may use the data in the affinity database, or similar data store, to determine one or more content elements and/or one or more interactive content elements (e.g., surveys, polls, games, quizzes, coupons, offers, or the like) to present to the user. For example, if the user has been searching for a mortgage, has contacted mortgage brokers or banks, has contacted realtors about selling a current home and/or buying a new home, or the like, the intelligence module 375 may capture this information in an affinity database, and may use the information to present various interactive content elements to the user, such as a realtor's slideshow of various listing, bank offers and rates, or the like. Furthermore, the content elements may solicit data from the user in the form of a survey, game, or the like, in conjunction with the presentation of a video or slideshow, for example, to gather and collect data associated with the user's interest in a mortgage, in moving, in selling their home, home design preferences, architectural preferences, or the like. Ultimately, the user's affinity information may be used to target, personalize, customize, and/or the like content elements that are presented to the user.

In some embodiments, the content elements may be organized as structured and unstructured data. As described above, content elements comprising structured data may include one or more multimedia elements and one or more corresponding interactive content elements that are preselected, predetermined, predefined, and/or the like, including the playback order of the interactive content elements, for playback for the user. For example, a user may create a content element that comprises a series of video clips with predefined survey questions between each video clip, and a playback order for each video clip and its corresponding survey question. In such an embodiment, the content element comprises structured data because the video clips, interactive content elements, and the order of presentation of the video clips and interactive content elements is predefined by the user.

On the other hand, content elements comprising unstructured data may include one or more multimedia elements and one or more corresponding interactive content element that are not preselected, predetermined, and/or predefined by the user that creates the content element. For example, the content creator may select an initial video clip to present to the user, which may also include one or more survey questions presented at the end of the video clip. In response to the user's response(s) to the survey question and/or the way the user interacts with the video clip (e.g., tracking where the user looked during playback of the video clip), the intelligence module 375 may dynamically determine one or more additional video clips (or other content elements) to present to the user.

The intelligence module 375, for example, may query one or more external data sources, artificial intelligence engines (e.g., IBM's Watson®), for additional content elements using the responses or other input that the user provides. Additionally, the intelligence module 375 may use input from the triggering event to determine the additional content elements to present to the user. Thus, the content that is selected for the user is dynamically determined in real-time based on the user's input, the descriptive data for the user stored in the affinity database, and/or triggering events. In other words, the intelligence module 275 provides a dynamic way to branch videos based on the user's responses to interactive content elements. The intelligence module 275 may also trigger signals to external devices based on a user's responses to cause an action to occur on the device (e.g., display content, etc.) to receive additional content to display to the user, or the like.

In another embodiment, the intelligence module 275 may include one or more instances of an artificial intelligence engine that it utilizes and maintains, in addition to, or separate from, external artificial intelligence engines offered by third-parties such as Google®, Microsoft®, Amazon®, or the like. As used herein, artificial intelligence refers to the ability of the devices within the system to learn and mimic human cognitive functions without user intervention. Thus, for example, as related to the subject matter disclosed herein, the ability to recommend and present content elements, offers, rewards, games, surveys, polls, etc., to a user based on the user's previous responses, preferences, triggering events, and/or the like. In other words, the intelligence module 275, in some embodiments, learns over time, based on the descriptive, historical, and preference data for a user, how best to target content to the user by connecting, interacting, communicating, or the like with other devices, databases, artificial intelligence engines, and/or the like.

The intelligence module 275 may also generate, create, use, or the like “evolving data.” As used herein, evolving data is data that is data that is related or relevant to a user's responses, preferences, answers, or the like. For example, when someone responds to a question about gardening, related questions may also be presented to the user, e.g., questions about housing, tools, home improvement stores, garden nurseries, and/or the like. Thus, the user may indicate that they are also in the market for a home, in refinancing their current mortgage, in certain gardening tools or plants, and/or the like. The intelligence module 275 may submit the user's answers/responses to an affinity database (such as follow.net) and associate their responses with gardening. This intelligence module 275 can then use this information to trigger other questions, content elements, multimedia elements, or the like to present to the user.

The intelligence module 275 may also determine content to present to the user based on the affiliate and/or affiliate commission associated with the content. Continuing with the example above, if the intelligence module 275 determines that the user is in the market for a new home, based on the user's responses, the intelligence module 275 may determine additional interactive content to present to the user to determine whether the user needs an appraisal, a home inspection, a moving company, a mortgage broker, a real estate lawyer, an accountant, or the like based on relationships, contracts, agreements, which may include affiliate commissions and fees, or the like with the various companies offering these services. Similarly, after the user purchases a home, the intelligence module 275 may present offers, coupons, advertisements, or the like for paint (e.g., in conjunction with an agreement with Benjamin Moore® or Sherwin Williams®), furniture, home electronics, hot tubs/spas, or the like. In this manner, the intelligence module 275 can select content, offers, advertisements, etc. to present to the user based on the relationship with a company, the ad revenue sharing offered by the company, an affiliate fee offered by the company, and so on.

The profile module 380, in one embodiment, generates a profile for the user based on the user's responses to one or more interactive content elements. The user's profile, as used herein, may include descriptive data for the user such as demographic data, purchase history, browsing history, responses to previous presented questions, preferences, interests, hobbies, habits, and/or the like.

In one embodiment, the response module 230 and/or the intelligence module 375 determines content elements to present to the user based on the descriptive data in the user's profile. For example, the intelligence module 375 may check the user's profile to determine the user's age and purchase history to provide recommendations, suggestions, survey questions, advertisements, multimedia content, or the like to present to the user while the user is in a retail store, or browsing the Internet, or the like. The user's profile may comprise, or be part of, the affinity database described above.

The agent module 385, in one embodiment, acts as a virtual agent for a company, organization, or the like. A virtual agent, as used herein, may be a bot, such as a chat bot or other software bot, that provides services to customers, clients, etc., that are conventionally performed by live persons using electronic communications such as text messaging, instant messaging, email, automated voice messaging, interactive video messaging, social media, or the like. In one embodiment, the agent module 385 may provide marketing services, advertising services, selling services, training services, customer service services, customer support services, or the like by determining content elements to present to the user for the service being offered. For example, the agent module 385 may receive a customer support query from a user via a text message and may determine content elements to present to the user, such as a “how-to” video, or the like, and also a survey during or at the end of the video, via a return text message, to get the user's responses to the video, e.g., to determine if the video was helpful, relevant, understandable, etc.

In another example embodiment, the agent module 385 may present an interactive video chat bot, e.g., in response to a user watching a video on Finland, that presents interactive video content in response to a user initiating an interactive video chat (as determined by the trigger module 225). The user, for example, may be interested in travelling to Finland, and may initiate an interactive video chat bot on the Air Finland website. To learn more about Finland, the interactive video chat bot may present a link to another interactive video that explains more about Finland (tourist info, food, lodging, customs, etc.). The user may then continue interacting with the chat bot to determine the best flights to book, the best tourist locations, the best lodging accommodations, or the like. The user may then book the flight, lodging, rental car, etc. via the chat bot.

The agent module 385 may access scripted or structured data for asking and responding to users based on input received from the user. For example, the agent module 385 may ask structured questions (e.g., closed-ended questions) to receive predictable responses from the user. Based on the responses, the next set of questions or other information may be presented to the user. In another embodiment, the agent module 385 uses a dynamically determined script or other unstructured data, which may occur in real time, using input or responses from the intelligence module 375 described above. For example, the agent module 385 may present open-ended questions, and may provide the user's responses to an artificial intelligence engine to dynamically determine additional content, questions, information, and/or the like to the user. In another example, the agent module 385 may learn about a user's travel needs over time, based on the user's previous responses to interactive content, calendar events, device interaction, browsing history, or the like (as analyzed by the intelligence module 375) to plan itineraries, book flights, book hotels, book rental cars, or the like.

The document module 390, in one embodiment, provides documents from a document repository and/or service, e.g., Box®, Drobox®, or the like, as part of the presentation of the content element. In one embodiment, the document module 390 checks one or more tags associated with various documents to determine whether the documents are relevant to the content presented to the user. For example, the document module 390 may filter and select documents from a Box® account, based on the tags assigned to the documents, to find documents related to mortgages for a real-estate video that the user is watching. In such an example, a video may be presented and tagged in such a way that documents are pulled out of the Box® account based on the tags, or at a particular point during playback of the video a question may be presented to determine whether the user has certain mortgage documents for a specific property that is presented on the video, and if so, the document module 390 can pull the documents from the Box® account, or a public records repository, or the like, and present them in the video, provide a link to download the documents, or the like. The document content may access other content from various repositories, such as photos or videos from a Google Photos® or YouTube® account, music files, web sites, and/or the like.

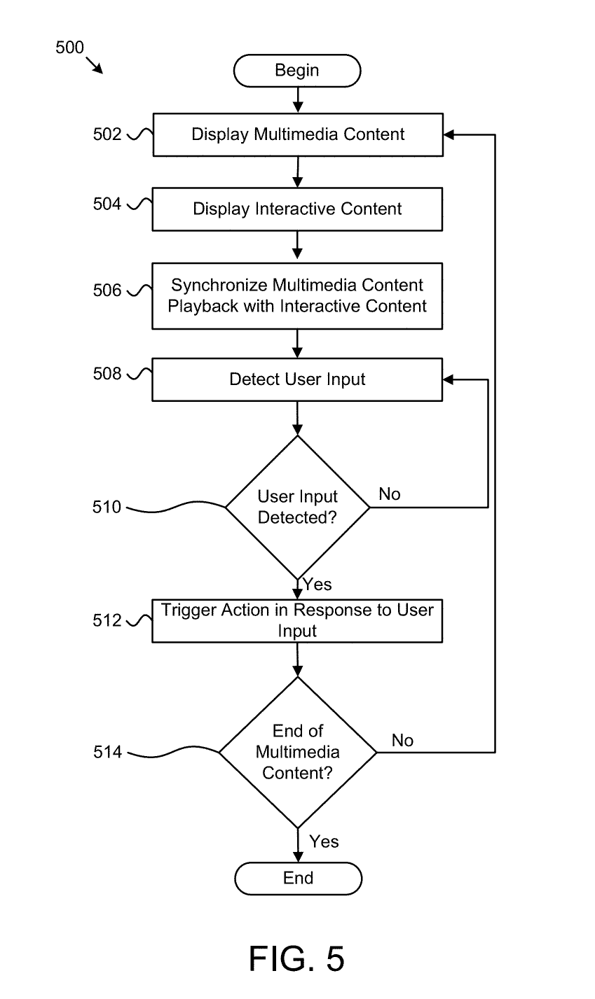

FIG. 5 is a schematic flow chart diagram illustrating one embodiment of a method 500 for synchronizing interactive content with multimedia. The method 500 begins and the media module 205 presents multimedia content to be displayed 502. The content module 210 presents one or more interactive content elements to be displayed 504 with the multimedia element. The media module 205 may present the visual and/or audible content by visually displaying the content on an electronic display of the client computer 106 and/or playing the audio file associated with the audible and/or visual content. The synchronization module 215 synchronizes 506 the one or more interactive content elements displayed by the content module 210 with the multimedia element displayed by the media module 205. In one embodiment, as the multimedia element is presented, the synchronization module 215 updates the interactive content in response to the segment of the multimedia being presented.

The input detection module 220 detects user interaction 508 with the interactive content and employs a trigger module 225 that performs an action in response to the user input 512. If the input detection module 220 does not detect 510 user input, it will continue to detect user input 510 and employ the trigger module 225 until the multimedia content has ended 514. If the multimedia content has not ended 514, the synchronization module 215 will continue to synchronize the multimedia element with the one or more interactive content elements. The input detection module 220 will continue to detect user input until the multimedia content is finished 514. Then the method 500 ends.

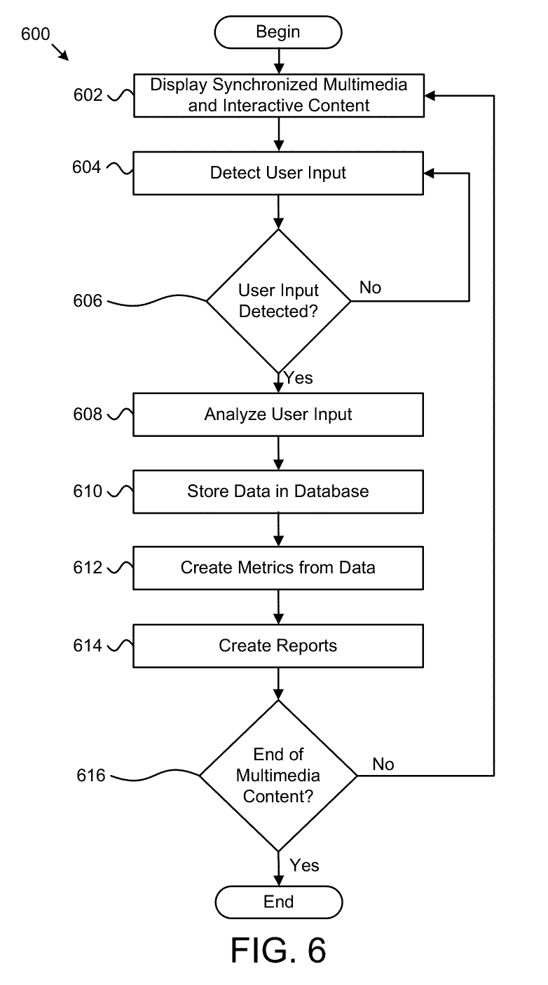

FIG. 6 is a schematic flow chart diagram illustrating an embodiment of a method 600 for synchronizing interactive content with multimedia. The method 600 begins and the synchronization module 215 synchronizes a multimedia element displayed 602 by the media module 205 with one or more interactive content elements displayed by the content module 210. The media module 205 may present the visual and/or audible content by visually displaying the content on an electronic display of the client computer 106 and/or playing the audio file associated with the audio and/or visual content.

The input detection module, in one embodiment, 220 detects 604 user input in response to a user interacting with an interactive content element. The method 600 will continue to detect 606 user input if it is not present. If user input is detected 606, the analysis module 310 analyzes 608 the input data. The data, in certain embodiments, may be stored in a database 610 for future use by additional modules and/or applications. The metrics module 315 may use the data 612 to create custom metrics regarding the user input detected by the input detection module 220. Further, the data may be used to create custom reports 614, such as recommendations, evaluations, and assessments in response to the user input detected by the input detection module 220.

If playback of the multimedia content has not finished 616, the method 600 will continue to display 602 the one or more interactive content elements synchronized with the multimedia element. Otherwise, the method 600 ends.

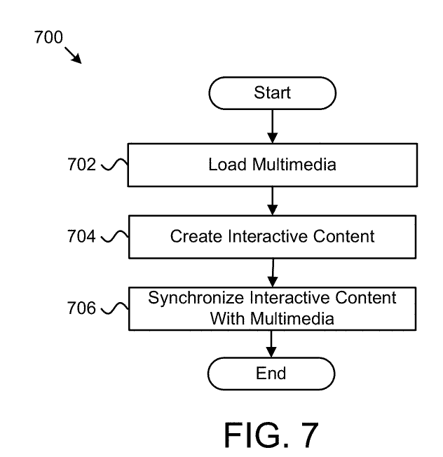

FIG. 7 is a schematic flow chart diagram illustrating an embodiment of a method 700 for loading, editing, and synchronizing one or more interactive content elements with a multimedia element. The method 700 begins and the loading module 340 loads a multimedia element 702 into a media player capable of multimedia playback. The editing module 345 provides an interface that the content creator may use to create and/or edit one or more interactive content elements 704. The timing module 350 synchronizes 706 the one or more interactive content elements with the multimedia element loaded by the loading module 340. Then the method 700 ends.

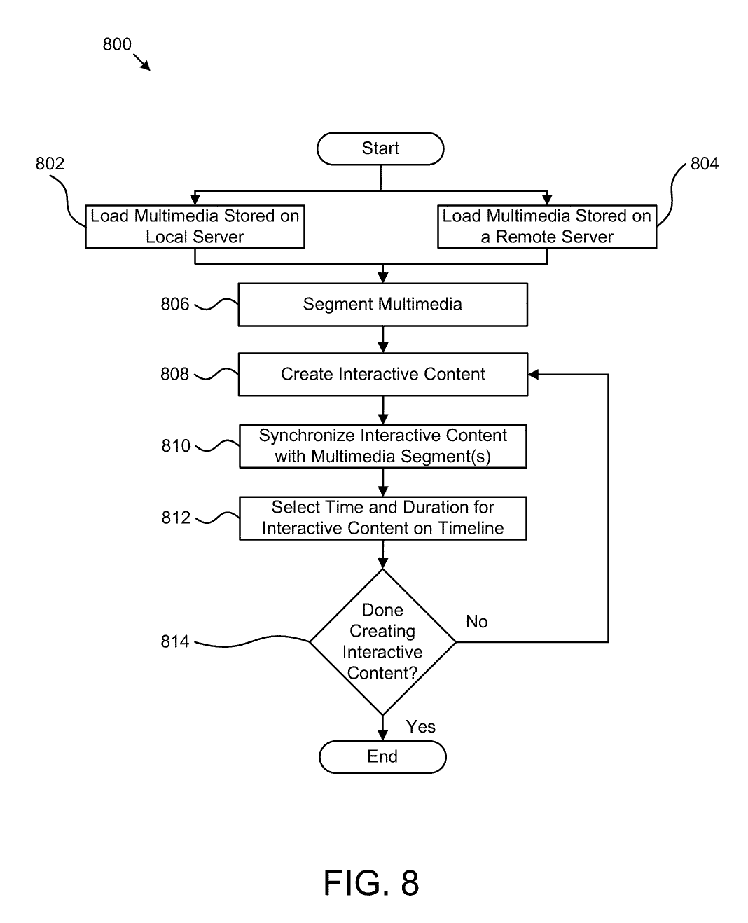

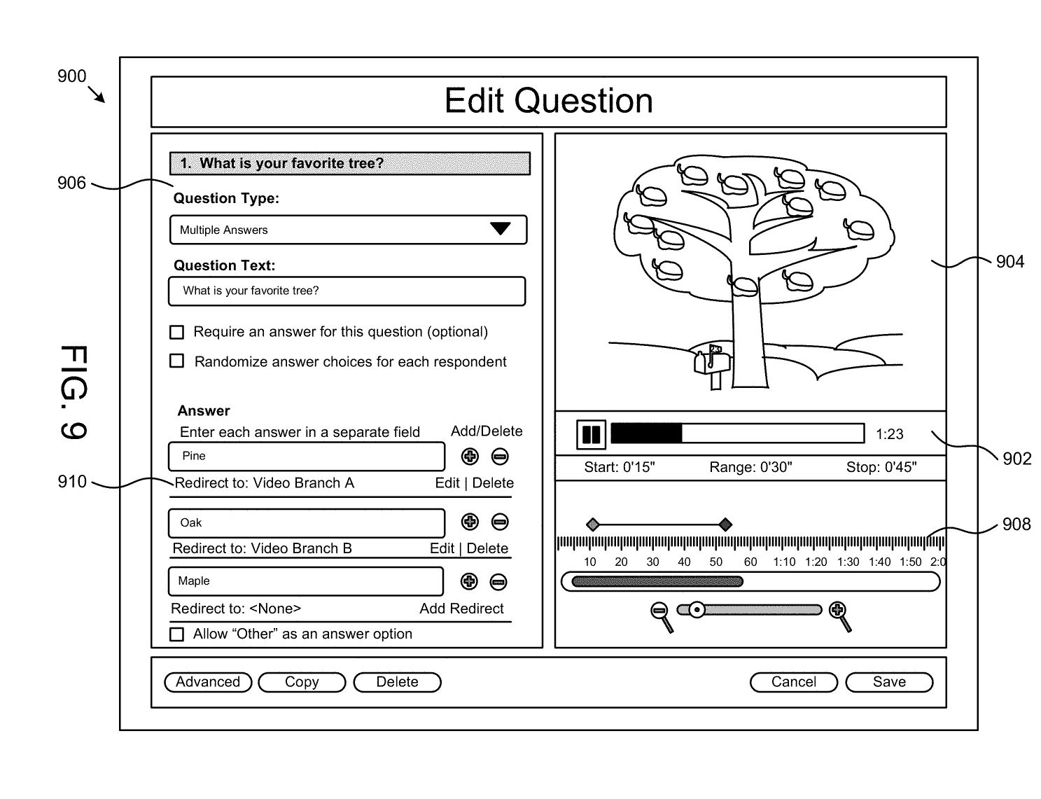

FIG. 8 is a schematic flow chart diagram illustrating another embodiment of a method 800 for loading, editing, and synchronizing one or more interactive content elements with a multimedia element. The method 800 begins and the loading module 340 loads a multimedia element that has been uploaded and stored on a local server 802 or loads multimedia stored on a remote server 804. The remote server may be a hosting site such as YouTube®, a cloud storage service such as Amazon® S3, or the like. The loading module 340 segments the multimedia element 806 into one or more segments.

The editing module 345, in one embodiment, provides an interface that a content creator can use to create and/or edit one or more interactive content elements 808. The timing module 350 synchronizes 810 the one or more interactive content elements with the multimedia element loaded by the loading module 340. In one embodiment, a timeline component may be used to select a time and duration 812 in the multimedia element for each of the one or more interactive content elements to be displayed. The one or more interactive content elements are then associated with the one or more multimedia segments, represented by the selected time and duration. The content creator may continue 814 to create one or more interactive content elements 808 if he is not finished assigning interactive content elements to the one or more multimedia segments. Otherwise, the method 800 ends.

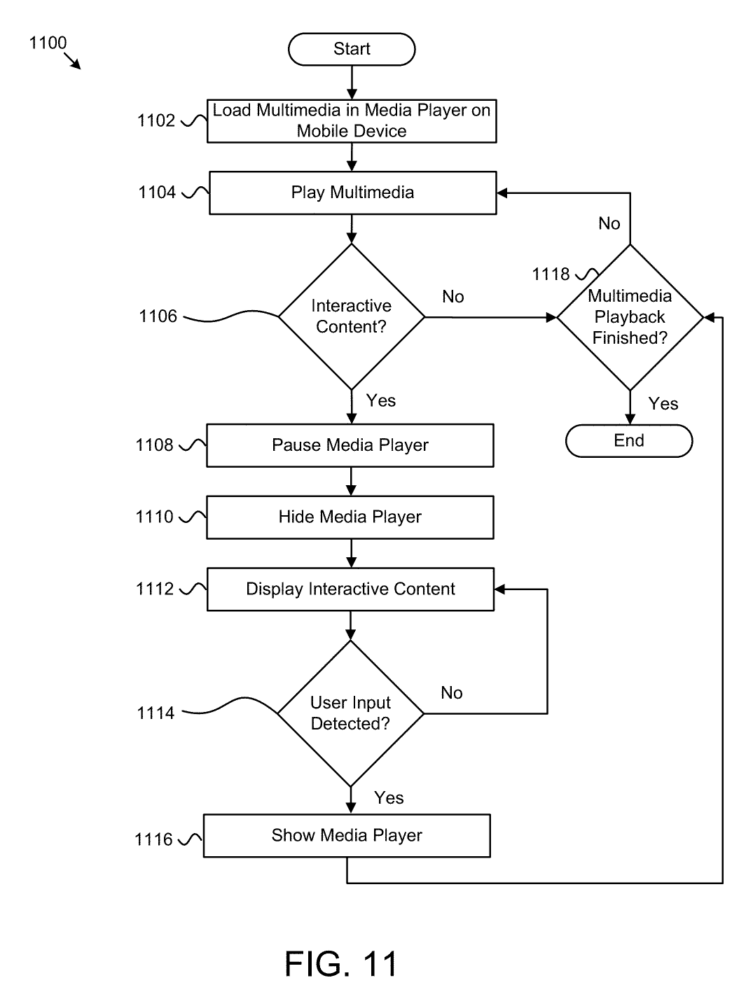

FIG. 11 is a schematic flow chart diagram illustrating one embodiment of a method 1100 for displaying multimedia and interactive content on a mobile device. The method 1100 begins and the media module 205 loads a multimedia element into a media player on a mobile device 1102 and begins playback 1104 of the multimedia element. The synchronization module 215 continues to check for interactive content from the content module 210. If there is no interactive content to display, and the multimedia element is not finished playing 1118, the media module 205 continues to play the multimedia element. If there is interactive content, the synchronization module 215 pauses 1108 and hides 1110 the media player while the content module 210 displays the interactive content 1112. The content module 210 continues to display the interactive content until user input is detected 1114. If user input is detected 1114, the content module 215 hides the interactive content and the media module 205 shows the media player to continue playback of the multimedia element 1116. If the multimedia element is not finished playing 1118, the multimedia element will continue playing 1104 and the synchronization module 215 will continue to check for interactive content 1106. Otherwise, the method 1100 ends.

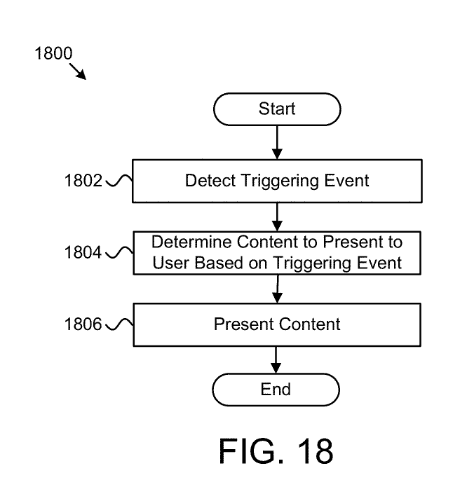

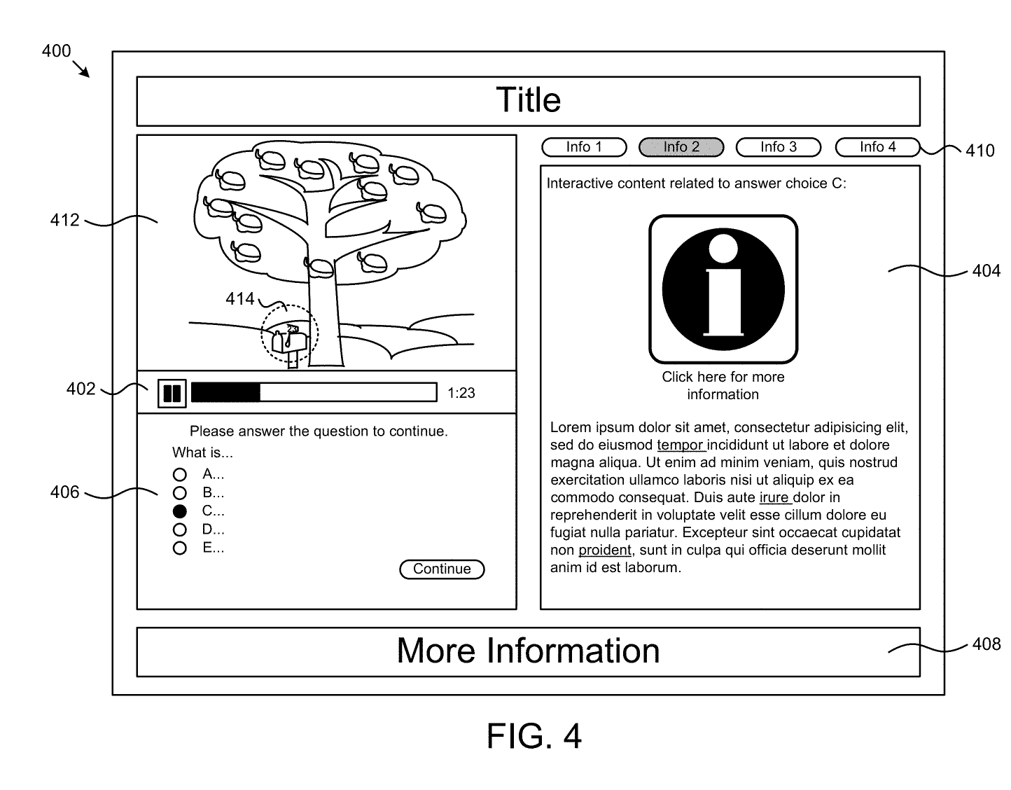

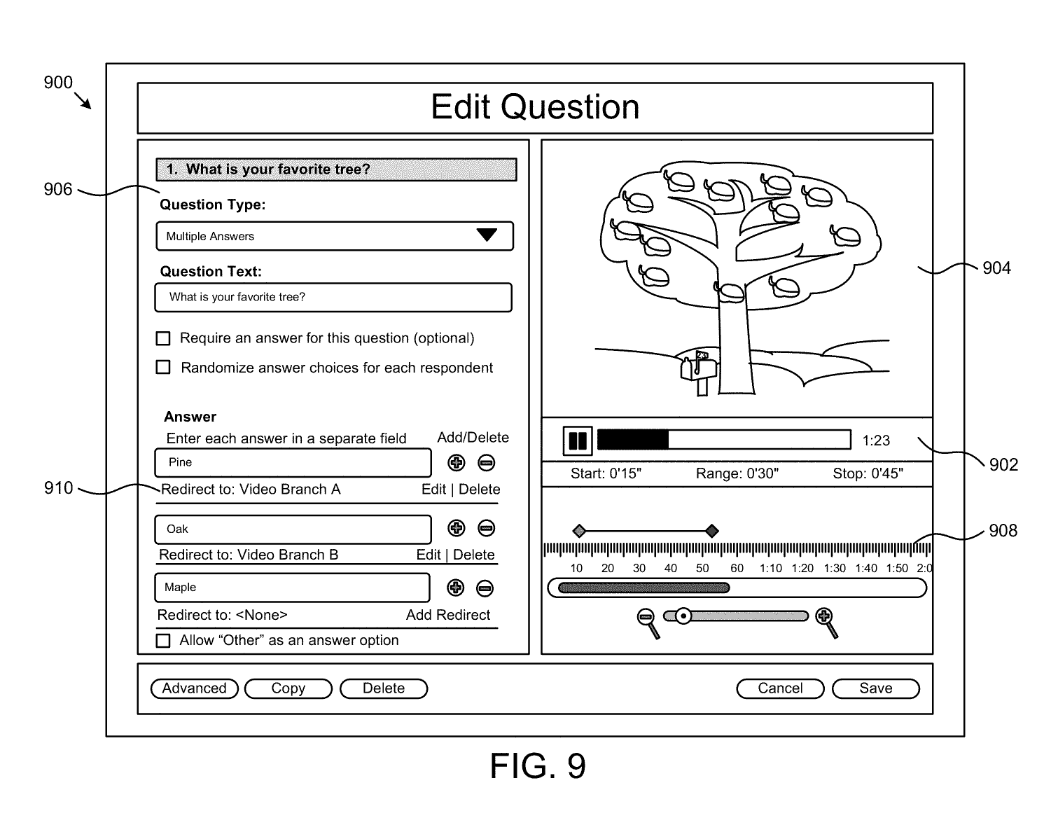

FIG. 18 is a schematic flow chart diagram illustrating one embodiment of a method 1800 for trigger-based content presentation. In one embodiment, the method 1800 begins and detects 1802 a triggering event. The triggering event may include, but is not limited to, receiving sensor input, receiving a signal from a different device, determining the user's location, determining a time of day, and/or the like.

In one embodiment, the method 1800 determines 1804 a content element to present to a user in response to the triggering event. The content element may include a multimedia element and one or more interactive content elements that are synchronized with the multimedia element such that the one or more interactive content elements are presented at predetermined points during presentation of the multimedia element.

In one embodiment, the method 1800 determines 1804 the content element dynamically in real-time based on the triggering event, input provided by a user, or the like. The method 1800, for example, may query or use artificial intelligence engines to determine content that should be presented to the user based on input associated with the triggering event, input received from a user (e.g., in response to an interactive content element such as a question, survey, poll, etc.), and/or the like. In another embodiment, the method 1800 determines 1804 the content element by selecting a content element that has been preselected or predetermined to be associated with the triggering event, with input received from the user, and/or the like. For example, the triggering event may be detected when the user is located at a retail store. When the user is detected at the retail store, the method 1800 may determine 1804 a content element for the retail store, e.g., a content element that provides coupons, offers, advertisements, etc., that has been assigned to that location so that when the user reaches that location, the content element will be pushed, or otherwise sent, to the user's device.

The method 1800, in a further embodiment, presents the determined content element to the user, such as on a user's device, on an external device within the user's proximity, and/or the like, and the method 1800 ends. In one embodiment, the trigger module 225, the response module 230, and the presentation module 235 perform the various steps of the method 1800.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a trigger module that detects a triggering event;
a response module that determines a content element to present to a user in response to the triggering event, the content element comprising a multimedia element and one or more interactive content elements that are synchronized with the multimedia element such that the one or more interactive content elements are presented at predetermined points during presentation of the multimedia element; and
a presentation module that presents the determined content element on a device of the user.

2. The apparatus of claim 1, further comprising an intelligence module that further determines the content element presented to the user based on descriptive data asssociated with the user, the descriptive data selected from one or more of a user profile and an affinity database.

3. The apparatus of claim 2, wherein the intelligence module determines one or more additional content elements to present to the user based on the triggering event, input received from the user, and the descriptive data associated with the user, the user input received in response to the user providing a response to the one or more of the interactive content elements.

4. The apparatus of claim 3, wherein the intelligence module queries one or more external data sources using the user input to determine the one or more additional content elements to be presented to the user.

5. The apparatus of claim 3, wherein the intelligence module dynamically determines the one or more additional content elements presented to the user in real time in response to the user interacting with the one or more interactive content elements.

6. The apparatus of claim 2, wherein the affinity database stores descriptive data comprising one or more of preferences, demographics, interests, and shopping trends of the user.

7. The apparatus of claim 1, further comprising a profile module that generates a profile for the user based on the user's responses to the one or more interactive content elements, the profile comprising descriptive data for the user.

8. The apparatus of claim 7, wherein the response module determines the content element presented to the user based on the descriptive data in the user's profile, wherein one or more of the multimedia element and the one or more interactive content elements are selected based on the descriptive data in the user's profile.

9. The apparatus of claim 1, wherein the response module determines the content element presented to the user from one or more preselected content elements for the user, each preselected content element comprising a multimedia element and one or more interactive content elements.

10. The apparatus of claim 9, wherein a content element of the one or more preselected content elements is selected for presentation to the user based on the user's response to one or more interactive content elements associated with a currently presented multimedia element.

11. The apparatus of claim 1, wherein the triggering event comprises receiving a signal from one or more external devices, the content element presented to the user determined based on the received signal.

12. The apparatus of claim 1, wherein the triggering event comprises receiving input from one or more sensors, the content element presented to the user determined based on the sensor input.

13. The apparatus of claim 1, wherein the triggering event comprises determining a location of the user, the content element presented to the user determined based on the determined location.

14. The apparatus of claim 13, wherein the determined location comprises a location within a store, the content element presented to the user associated with one or more products related to the user's location.

15. The apparatus of claim 1, wherein the trigger module sends a signal to one or more external devices in response to user input, the signal triggering one or more actions on the one or more external devices.

16. A method comprising:
detecting a triggering event;
determining a content element to present to a user in response to the triggering event, the content element comprising a multimedia element and one or more interactive content elements that are synchronized with the multimedia element such that the one or more interactive content elements are presented at predetermined points during presentation of the multimedia element; and
presenting the determined content element on a device of the user.

17. The method of claim 16, further comprising determining the content element presented to the user based on descriptive data associated with the user, the descriptive data selected from one or more of a user profile and an affinity database, wherein one or more additional content elements presented to the user are determined based on the triggering event, input received from the user, and the descriptive data associated with the user, the user input received in response to the user providing a response to the one or more of the interactive content elements.

18. The method of claim 17, further comprising dynamically determining, in real time, the one or more additional content elements presented to the user.

19. The method of claim 16, further comprising determining the content element presented to the user from one or more preselected content elements for the user, each preselected content element comprising a multimedia element and one or more interactive content elements, wherein a content element of the one or more preselected content elements is selected for presentation to the user based on the user's response to one or more interactive content elements associated with a currently presented multimedia element.

20. A computer program product comprising a computer readable storage medium having computer readable program code embodied therewith, the computer readable program code configured to:
detect a triggering event;
determine a content element to present to a user in response to the triggering event, the content element comprising a multimedia element and one or more interactive content elements that are synchronized with the multimedia element such that the one or more interactive content elements are presented at predetermined points during presentation of the multimedia element; and
present the determined content element on a device of the user.
